(19) United States
(12) Patent Application Publication
(10) Pub. No.: US 2024/0217782 A1
(43) Pub. Date: Jul. 4, 2024

(54) UPEND CRANE AND INSTALLATION VESSEL

(71) Applicant: Itrec B.V., SCHIEDAM (NL)

(72) Inventors: Diederick Bernardus WIJNING, SCHIEDAM (NL); Joop ROODENBURG, SCHIEDAM (NL)

(73) Assignee: Itrec B.V., SCHIEDAM (NL)

(21) Appl. No.: 18/288,732

(22) PCT Filed: Apr. 29, 2022
(86) PCT No.: PCT/EP2022/061622

§ 371 Date: Oct. 27, 2023

(30) Foreign Application Priority Data
Apr. 30, 2021 (NL) 2028124
Jul. 15, 2021 (NL) 2028741
Aug. 27, 2021 (NL) 2029075
Feb. 3, 2022 (NL) 2030818

(51) Int. Cl. B66C 23/18; B63B 75/00; B66C 1/10; B66C 23/52; F03D 13/10

(52) U.S. Cl. CPC B66C 23/185; B63B 75/00; B66C 1/108; B66C 23/52; F03D 13/126; F03D 13/139

(57) ABSTRACT

In an upend crane and an installation vessel including such an upend crane, the upend crane is provided with a boom configured for upending wind turbine components, e.g. monopiles and masts. The boom of the crane can be pivoted in an upend position for upending the wind turbine component with the bottom end of the wind turbine component being guided by a cart and a track along an upend deck and with the top end of the wind turbine component being guided along the boom by a trolley and the trolley guide.

### FIELD OF THE INVENTION

An offshore wind turbine comprises a mast supporting a nacelle and the blades of the wind turbine. The mast is mounted on a foundation, typically in the form of a monopile, i.e. a cylindrical foot section, part of which is driven into the sea floor. As an alternative foundation, a jacket, i.e. a truss or frame work installed on the sea floor, can be used.

At present many offshore wind turbine parks are planned to allow for a significant electricity production. For reasons of efficiency the wind turbines have an ever increasing capacity and size. Nowadays 5 MW turbines and 8 MW are being planned. In the future even 14 MW turbines are envisaged. In known designs a 8 MW turbine has a diameter of the hub with blades of 160 metres combined with a height of the hub at about 120 metres above sea level. A proposed 14 MW turbine has a blades diameter of 220 metres combined with the hub at about 160 metres above sea level.

The weight of a wind turbine including mast, nacelle and blades, at least in future designs, may well be over 1000 t. The foundation itself may well weigh several hundred tonnes, e.g. depending on the type of foundation. Many types of foundations are discussed in US2007/243063. For example JP2018053899 and EP3153398 relate to floating type foundations.

The foundation is installed first by driving the pile into the sea bottom after which the wind turbine, the wind turbine comprising a mast, nacelle and blades, is installed on the pile. Again, either by installing the wind turbine at once as a whole or by assembling the wind turbine in parts on the pile. A transition piece may be provided between the pile and the mast of the wind turbine.

To facilitate transport of monopiles to the installation sight, the piles are transported to the installation site in a horizontal position. Storing the monopiles in a horizontal position keeps the center of gravity of these monopiles close to the water surface, which is beneficial for the vessel transporting the monopiles.

At the installation site, the monopiles have to be upended, i.e. a top end of the monopile is lifted relative to a bottom end of the monopile to bring the pile from the horizontal position into a vertical or upright position.

For example from WO2019103611 it is known to transport monopiles in a horizontal position, and to, at the installation site, up end the monopiles using two deck mounted cranes. The monopiles are stored on the deck of the vessel between two deck mounted cranes. Furthermore, the monopiles are stored with a top end in an overboard position, and with a bottom end supported on a track cart, which track cart is mounted on a track. To upend the monopile, the two cranes lift a top end of the monopile and the bottom end of the pile is guided along the guide track.

For example from WO2019231329 a similar process is known, wherein the monopiles are upended by a single crane. The bottom end of the monopiles is supported by a monopile gripper that tilts with, and supports, the monopile during the upending.

A monopile may have a diameter of 10 meter or more, a length of 60 meters or more and a weight of 500 mt or more. There is a trend towards larger wind turbines and a desire to install offshore wind turbines at locations with larger water depths than currently encountered. Both result in larger and heavier foundations. Hence, it is expected that in the near future monopiles need to be installed that are larger than 100 meters, possibly 120 meters or larger. The weight of such piles may be larger than 1000 mt, possibly 1300 mt or above.

Also, there is a trend towards cost reduction in installing off shore wind turbines, in particular to increasing the efficiency of wind turbine installation. This can for example be achieved by shortening the installation process and by enlarging the operational window, i.e. making the installation process less dependent of the circumstances, such as wind, heave, etc.

### OBJECT OF THE INVENTION

The invention relates to a vessel and a method for installation of a foundation of an offshore wind turbine, in particular of monopiles. It is an object of the invention to provide an alternative installation vessel and method for upending monopiles. It is a further object of the invention to provide an improved installation vessel and method for upending monopiles. It is a further object of the invention to provide a installation vessel and method for upending monopiles that allow for a more controlled upending process, and to thus preferably allow for an enlarged operational window.

It is furthermore proposed to assemble wind turbine offshore, i.e. on a dedicated vessel. Thus, the wind turbines can be transported pre-assembled to the installation site, which is much easier than transporting an assembled wind turbine over large distances. At the installation location, the wind turbine is assembled and installed on a foundation, e.g. a foundation pile or floating foundation.

### SUMMARY OF THE INVENTION

The invention therefore provides an upend crane according to claim 1.

An upend crane, to be supported by the hull of a vessel adjacent an upend deck for upending wind turbine components, e.g. piles or masts, according to claim 1 comprises:
a crane base,
a crane housing and a slew bearing provided between the crane base and the crane housing, wherein the slew bearing enables the crane housing to slew about a vertical slew axis;
a boom, wherein the boom extends between a base end and a top end, wherein the boom is at the base end pivotable supported by the crane housing for pivoting between a lowered position for lifting a load at a distance from the crane base and a raised upend position for upending wind turbine components, e.g. monopiles and masts, adjacent the crane base;
a luffing winch and an associated luffing wire, e.g. a luffing assembly comprising a luffing winch and an associated luffing wire, wherein the luffing winch is mounted on the crane housing and the luffing wire extends between the luffing winch and the boom, to enable pivoting the boom between the lowered and the raised upend position; and
a hoist, e.g. a hoisting assembly comprising a hoist, wherein the hoist comprises a hoisting winch and an associated hoisting wire, wherein the hoisting wire is guided via an upper sheave assembly in the boom to a lower sheave assembly of the load coupling device for coupling with a load, e.g. a top end of a wind turbine component, to enable the crane to lift the load using the hoisting winch;
a trolley guide, e.g. a track comprising one or more guide rails, mounted to the boom of the crane; and
a trolley, coupled with the trolley guide for being guided along the boom of the crane, wherein the trolley is provided with a wind turbine component engagement device that is configured to pivotably support a wind turbine component at the top end thereof, or wherein the trolley is configured to receive a wind turbine component engagement device and/or a load coupling device supporting a wind turbine component engagement device.

A wind turbine component may refer to a pile, or a foundation pile, for supporting the mast of a wind turbine, or to a mast, for supporting the nacelle of a wind turbine.

With a crane according to the invention, the boom of the crane can be pivoted in an upend position for upending the wind turbine component with a top end of the wind turbine component guided by the trolley. This allows for controlled upending, in particular with large and heavy monopiles and wind turbine masts.

The pivotable boom can be pivoted between a lowered hoist position for lifting a load at a distance from the crane base and a raised upend position for upending wind turbine components into an upright position adjacent the crane base. The crane preferably is set up at an end of an upend deck with a cart track and a support cart for guiding the bottom end of the wind turbine component during the upend process. The boom of the crane is provided with a trolley guide and an trolley for guiding the top end of the monopile during the upending process.

Thus, the upend crane according to claim 1 allows for guiding both the bottom end and the top end of the wind turbine component during the upend process, and therefore enables a more controlled movement of the wind turbine component during upending. Supporting the top end of the wind turbine component during the upending process provides the wind turbine component with additional stability, which is beneficial when upending large and/or heavy monopiles.

For example, when upending a monopile in the prior art the top end of a monopile is supported by a crane, which allows for swing of the top end. Guiding the top-end of the monopile according to the invention allows for a more controlled process, more in particular allows for a more controlled movement of the top end of the monopile. This is in particular beneficials when upending large and heavy monopiles. Also, when the movement of the top end of the monopile is controlled by a trolley, the top end is not moved by wind or swing of the vessel, which might be the case when the top end is supported by a traditional crane. Thus, with the crane according to claim 1 the upending process is less susceptible to weather, and allows for a larger operational window.

In an embodiment a crane according to the invention is mounted on a vessel, the vessel comprising an upend deck, a cart track extending along the upend deck and a support cart for supporting a bottom end of the monopile, wherein the support cart is supported by the cart track to enable the cart to move along the cart track for guiding the bottom end of the monopile along the upend deck from a position distal form the crane to a position adjacent the crane. In such an embodiment, the boom of the crane can be pivoted in an upend position for upending the monopile with the bottom end of the monopile being guided by a cart and a track and with the top end of the monopile being guided by the trolley and the trolley guide.

According to a further aspect, the invention provides a vessel that enables transporting a pre-assembled wind turbine, or parts thereof, and is configured for assembling the wind turbine at or near the installation site. In particular, the vessel is configured for upending the mast of the wind turbine, and preferably for mounting and testing of the nacelle, hub and blades, on the mast.

The upend crane according to the invention allows for upending a mast of a wind turbine offshore. In particular, due to the upend boom, the mast can be upended in a controlled manner. Furthermore, in an embodiment the upend crane can also be used for assembling the wind turbine.

The invention therefore enables assembling wind turbines offshore, and thus obviates the need for costly wind turbine installation plants located adjacent sea harbors. Furthermore, it is not necessary to transport assembled wind turbines over sea, which is time consuming and can only be done in limited weather windows.

In this approach the wind turbine foundation, based on the sea floor or of the floating type, may be pre-installed and the upend crane may be used to install the assembled wind turbine, i.e. mast with nacelle, hub and blades, on the foundation.

It is noted that is known to provide a vessel with a rigid upright tower provided with a trolley guide and an trolley for upending a monopile. This type of construction is not provided with a pivotable boom, and therefore is not configured for lifting a load at a distance from the tower. An up end crane according to claim 1 is configured for controlled upending, i.e. guiding the top end of a wind turbine component, and for lifting a load, i.e. lifting a load with the boom in a lowered position and preferably for pivoting the boom while supporting the load to thus move the load towards or away from the base of the crane.

The crane according to claim 1 can be used with a floating vessel, i.e. a non-jack-up type floating hull, that is configured to maintain a position and orientation relative to an installation site. Thus, the vessel does not need to be anchored or jacked up to enable installation of a monopile, which allows for a fast process. Furthermore, such a vessel can be deployed in deeper water, for the installation of large size monopiles, as well.

The boom of the crane can be pivoted in a lowered hoist position to enable the crane to lift a load at a distance from the crane base. Furthermore, by pivoting the boom while the crane supports a load, the load can be moved towards or away from the base of the crane. When the boom is raised in the upend position, it is in a substantially vertical or upright position. When the load coupling device, supported by the hoisting wire of the hoisting winch, is engaged by the trolley, the trolley can be used to guide the load coupling device along the boom of the crane. Thus, sway of the load coupling device relative to the boom is prevented, and the top end of a wind turbine component supported by the load coupling device can be moved along the boom in a controlled manner.

With a crane according to the invention, the boom of the crane can be pivoted in an upend position for upending the wind turbine component with the bottom end of the wind turbine component being guided by a cart on a upend track, or cart track, and with the top end of the wind turbine component being guided by the trolley and the trolley guide. Preferably, when the boom is in the upend position, the boom, or at least the trolley guide mounted to the boom, extends in an essentially vertical direction.

In a further embodiment, the crane housing is provided with a boom support for engaging the boom when in the upend position, which boom support prevents the boom from moving beyond the upend position. In addition or as an alternative, the crane is provided with boom securing means for securing the boom in the upend position during the upend process.

In an embodiment a crane according to the invention is mounted on a vessel, the vessel comprising an upend deck, a cart track extending along the upend deck and a support cart for supporting a bottom end of the monopile, wherein the support cart is supported by the cart track to enable the cart to move along the cart track for guiding the bottom end of the monopile along the upend deck from a position distal form the crane to a position adjacent the crane. In such an embodiment, the boom of the crane can be pivoted in an upend position for upending the monopile with the bottom end of the monopile being guided by a cart and a track and with the top end of the monopile being guided by the trolley and the trolley guide.

In such an embodiment, the boom of the crane can be pivoted in an upend position for upending the monopile with the bottom end of the monopile being guided by the cart and the upend track, or cart track, and with the top end of the monopile being guided by the trolley and the trolley guide.

In an embodiment, the crane comprises a boom securing device, the boom securing device comprising a stop for positioning the boom in the upend position, and a boom locking device, for securing or locking the boom in the upend position. Such a boom securing device is for example provided on a gantry that is mounted on, or is part of, the crane housing. By securing the boom, it is prevented that the boom moves out of the upend position during the upend process, and preferably the boom is fixed in position, to prevent any pivoting of the boom.

In a further embodiment, the boom securing device comprises an active damper, e.g. hydraulic cylinders, that resiliently engage the boom, when the boom is moved into the upend position, e.g. engage the boom when it is at an angle of 3 degrees with the vertical. In an embodiment, boom restrainer comprises hydraulic cylinders that are forced into an extend position. Thus, when the boom pivots upwards and engages the cylinders, the cylinders provide a resilient force that pushes the boom in the downward direction.

Thus, when the boom is a the top zone it is engaged by the damper, and when it is lowered out of the top zone, the damper disengages the boom. In an embodiment, the damper engages the boom when the boom is at an angle of 6 degrees or less, for example 3 degrees or less with the vertical.

In an embodiment, the crane comprises a boom mobiliser, for moving the boom out of the upend position, e.g. a hydraulic cylinder for pushing the boom away from the upend position, or a winch with association wire for pulling the boom away from the upend position. Thus, after the upend process, the boom can be pivoted out of the upright position. It is noted that the luffing wires may only effectively support the boom, and enable lowering of the boom, when the boom is out of the upright position, e.g. is at an angle of 3 degrees or more with the vertical. Thus, the boom mobiliser can be used to move the boom from the upright position into a position in which the luffing wires can support the boom.

In a further embodiment, the boom mobiliser is integrated in the boom securing device, for example the boom securing device comprises hydraulic cylinders that function as a damper for receiving the boom when pivoted into the upend position and that push the boom out of the upend position after the upending process.

In an embodiment, the trolley is configured to engage the load coupling device for guiding the load coupling device, and thus for guiding the top end of the wind turbine component, e.g. a monopile, supported by the load coupling device, along the trolley guide while upending the monopile using the hoist.

In an embodiment, the load coupling device of the crane is configured to be coupled with a monopile engagement device, e.g. a monopile top end clam, that is configured to pivotably support a monopile at the top end thereof.

In an embodiment, the trolley is configured to be coupled with a wind turbine component engagement device. The monopile engagement device preferably is configured to pivotable support the top end of the wind turbine component, to enable the monopile to pivot relative to the load coupling device and the trolley during upending.

In an embodiment, the load coupling device and the trolley are configured to be coupled, and the trolley is provided with a load coupling device configured to be coupled with the top end of the wind turbine component. In such an embodiment, the hoisting wire of the hoisting winch supports a load coupling device that can be used for coupling to the trolley. When the boom is raised in the upend position and the load coupling device, that is supported by the wire of the upend winch, is connected to the trolley, the trolley can be used to upend a wind turbine component.

When the boom is lowered from the upend position into a hoist position, and the load coupling device is not coupled with the trolley, the load coupling device can be used to lift a load at a distance from the crane base.

In an embodiment, the crane further comprises a secondary hoist comprising a secondary hoisting winch with an associated secondary hoisting wire supporting a secondary load coupling device configured to be connected to a load, and wherein the hoisting wire is guided via a crown block to the load coupling device for lifting a load at a distance from the crane base using the secondary hoisting winch.

In such an embodiment, the crane is provided, in addition to the hoist with a secondary hoist, the secondary hoist comprising a secondary hoisting winch for, when the boom is a lowered position, lifting loads at a distance from the base of the crane. In an embodiment, the secondary hoist is configured to lift and lower the trolley along the trolley guide, more in particular to move the trolley along the trolley guide in a position to engage or disengage the load coupling device of the main hoist.

In an embodiment, the trolley is configured to engage the load coupling device such that when they are coupled, the trolley moves with the load coupling device along the trolley guide. Thus, the main hoist can be used to move the trolley along the trolley guide.

In an embodiment, the boom is at the base end pivotable supported by the crane housing for pivoting about a horizontal boom pivot axis between a lowered position and a raised position for lifting a load and for moving that load towards or away from the crane base, and the trolley guide extends below the horizontal boom pivot axis when the boom is in the upend position.

In such an embodiment, the trolley guide extends along the boom of the crane and below the boom of the crane. Thus, the trolley can not only be moved along the boom of the crane, but can be lowered below the boom of the crane, when the boom is in the upend position. Extending the trolley guide below the boom pivot axis allows for lowering the trolley below the boom pivot axis, and thus for moving the trolley closer to the upend deck. This is for example beneficial when the boom pivot axis is positioned at some distance above the upend deck of the vessel. Because the trolley can be moved close to the upend deck

In a further embodiment, the lower section of the trolley guide, preferably the section that extends below the boom pivot axis, is mounted to the crane housing and is hingeable connected to the section of the trolley guide connected to the boom, or is separate or separable from the trolley guide connected to the boom, such that it does not pivot with the boom, and with the trolley guide connected to the boom, when the boom is pivoted about the boom pivot axis.

In an embodiment, the trolley guide comprises a boom section that is mounted to the boom of the crane, and a base section that is mounted to the base of the crane, and a trolley can be lowered from the boom section onto the base section into a position close to the upend deck for coupling the trolley with the top end of the monopile, and the trolley can be moved from the base section onto the boom section to upend the monopile that is coupled to the trolley.

In this embodiment, the trolley guide comprises a base section that is mounted to the base of the crane, and thus extends along the base of the crane, and below the boom pivot axis. Thus, the base section of the trolley guide does not move with the crane housing and the boom when these are slewed about the vertical axis.

It is submitted that it is also possible to provide the crane housing with section of the trolley guide, i.e. an intermediate section that, when the boom of the crane is in the upend position, forms an intermediate between the boom section and the base section of the trolley guide. The intermediate section is mounted to the crane housing, and therefore does not pivot with the boom of the crane. In contrast with the base section of the trolley guide, the intermediate section moves with the part of the crane that can be slewn about a vertical slew axis.

The base section of the trolley guide preferably is aligned with the cart track, such that it can be used to lower the trolley in a position close to the deck and in alignment with the cart track, and to thus enable guiding the load coupling device in a position close to the deck. Guiding the load coupling device close to the deck allows for engaging a monopile that is set up close to the deck. When the trolley cannot be lowered close to the deck, the lower section of the upending movement may not be guided, and therefore may not be optimally controlled. This configuration allows for a compact trolley and/or wind turbine component engagement device. Furthermore, the track can be set up close to the deck, and does not have to be raised, to present the wind turbine component at a height that allows for the top of the wind turbine component to be coupled with the load coupling device and for a controlled fully controlled, i.e. guided, upend movement.

Preferably the base section of the boom guide is dimensioned to receive the trolley. Thus, the trolley can be parked on the base guide section of the trolley guide. When the trolley is parked on the base guide section, the boom of the crane can be operated without it supporting the trolley. This is in particular beneficial when the crane is to be used to lifting a load, and not for upending a wind turbine component.

In a further embodiment, the base of the crane is provided with multiple trolley guide base sections, that each can be aligned with the trolley guide boom section by slewing the crane house in the correct position.

In an embodiment, the one or more trolley guide bases are configured to park one or more secondary trolleys, e.g. a secondary trolley that can be used in combination with the trolley supporting the top end of the wind turbine component, for engaging a lower end of the wind turbine component to stabilise the wind turbine component when it is lifted by the crane, or a secondary trolley configured to be used instead of the main trolley, wherein the secondary trolley is configured to engage and support a nacelle or wind turbine blades for assembling a wind turbine.

In an embodiment, the trolley guide comprises a boom section that is provided with a lower section that extends below the pivot axis of the boom, and the base section of the trolley guide aligns with this lower section of the boom guide when the crane is slewed in the correct position. In an alternative embodiment, the base section of the trolley guide extends up to, or beyond, the boom pivot axis.

In an embodiment, the crane is configured to enable mounting blades to the hub of the nacelle, the nacelle preferably being mounted on a mast that is supported in an upright position on the vessel.

In an embodiment, the trolley guide comprise one or more guides, e.g. one or more rails, and the trolley is provided with guide engagement devices, for example guide wheels, that engage the guides, and that movable secure the trolley to the trolley guide. Thus the trolley can only move along the trolley guide and not in a direction perpendicular to the trolley guide.

In an embodiment, the upend crane is mounted on a vessel having a upend deck and the vessel furthermore comprises a storage deck, supported by the hull of the vessel, wherein the storage deck is provided with storage racks for supporting multiple wind turbine components, e.g. monopiles or masts, in a horizontal position, wherein the storage deck and the storage racks are configured to support multiple wind turbine components parallel to each other and preferably parallel to a longitudinal axis of the vessel.

In an embodiment, the storage racks are configured to support a row of multiple, for example three, wind turbine components on the storage deck. In a further embodiment, the storage racks are configured to support two or more rows, one row stacked upon the other row, of multiple wind turbine components. Preferably the storage deck is located adjacent the upend deck, and the wind turbine components are stored on the storage deck parallel to the cart track. This facilitates moving the wind turbine components from the storage deck to the upend deck an onto the cart track, because the orientation of the wind turbine components does not have to be changed when they are lifted from the storage deck onto upend deck.

In an embodiment, the upend crane is mounted on a vessel and is located at one end of the storage deck, and the vessel is provided with a storage crane at an opposite end of the storage deck, and wherein the upend crane and the storage crane are configured to together lift a wind turbine components from the storage deck to the upend deck, the crane and the storage crane each lifting an end of the wind turbine components. In such an embodiment, the crane and the storage crane are positioned to lift a wind turbine components in a horizontal position form the storage deck onto the upend deck. In a further embodiment, the cranes can furthermore be used to lift a wind turbine components from a supply vessel or from the quay onto the storage deck.

In an embodiment, the upend deck and storage deck are both part of a single vessel deck.

In an embodiment, the upend deck and the crane are configured such that the wind turbine components, when supported in a horizontal position on the upend deck and with the top end of the wind turbine components coupled to the load coupling device, is parallel to a longitudinal axis of the vessel.

In an embodiment, an active horizontal motion device is mounted between the trolley and the load coupling device, when received in the trolley, and/or a wind turbine component engagement device supported by the load coupling device, the active horizontal motion device being adapted to actively compensate for sea-state induced horizontal displacement of the wind turbine component engagement device relative to an installation location in two non-parallel horizontal directions, e.g. in orthogonal horizontal directions, while the wind turbine component is supported in an upright position by the wind turbine component engagement device.

In a further embodiment, the active horizontal motion device comprises one or more motor powered displacement actuator assemblies, e.g. a hydraulic power assembly including a pump and one or more hydraulic cylinders or a winch assembly.

In an embodiment, the active horizontal motion device is configured to be used for damping movement of the top end of the wind turbine component during the upending and/or during the lowering of the wind turbine component. For example, during the upending of a foundation pile, for example roll of the vessel and/or wind may cause the top end of the foundation pile to sway relative to the trolley. Instead of providing a super rigid connection between foundation pile and the trolley, the active horizontal motion device may be configured to dampen and absorb the swaying movement of the top end of the foundation pile.

Also, when a foundation pile is lowered into the sea, while being guide by a pile gripper, sea currents may cause the movement of the pile, for example may cause the pile to pivot relative to the pile gripper. The active horizontal motion can be used for damping movement of the top end of the wind turbine component. In a further embodiment, a control system that controls the active horizontal motion device is linked to an active horizontal motion device that supports the gripper, such that movement of the gripper and the load coupling device, can both be controlled to optimally dampen movement of the foundation pile and for optimally positioning the foundation pile in a vertical position above the foundation installation location.

In an embodiment, the trolley is provided with a wind turbine component engagement device that is configured to pivotably support a wind turbine component at the top end thereof and wherein the trolley is configured to be coupled with the load coupling device of the hoist.

In an embodiment, the trolley is configured to receive a wind turbine component engagement device that is supported by load coupling device of the hoist.

In an embodiment, the trolley is configured to receive the load coupling device of the hoist, which load coupling device is supporting a wind turbine component engagement device that is configured to pivotably support a wind turbine component at the top end thereof.

In an embodiment, the trolley is configured to receive a wind turbine component engagement device that is supported by the load coupling device of the hoist.

In an embodiment, the crane further comprises a trolley hoist comprising a trolley hoisting winch with an associated trolley hoisting wire, and wherein the trolley hoisting wire is guided via a crown block to the trolley for moving the trolley along the trolley guide. In such an embodiment, the hoist of the crane is used when lifting loads, and the trolley hoist is used, for moving the trolley, when upending wind turbine components.

In an embodiment, the crane further comprises a secondary hoist comprising a secondary hoisting winch with an associated secondary hoisting wire supporting a secondary load coupling device configured to be connected to a load, and wherein the hoisting wire is guided via a crown block to the load coupling device for lifting a load at a distance from the crane base using the secondary hoisting winch.

The invention furthermore provides an installation vessel, for installation and preferably transport of wind turbine components, e.g. monopiles or masts, the installation vessel comprising:
a hull, the hull forming an upend deck,
an upend crane according to the invention, wherein the upend crane is supported by the hull of the vessel adjacent the upend deck,
a cart track, extending along the upend deck;
a support cart for supporting a bottom end of the wind turbine component, wherein the support cart is supported by the cart track to enable the cart to move along the cart track for guiding the bottom end of the wind turbine component along the upend deck from a position distal from the crane to a position adjacent the crane;
a gripper, the gripper extending outside a contour of the vessel, e.g. for guiding a monopile being lowered in a vertical position into the water adjacent the vessel or for engaging, and preferably stabilising, a floating foundation for mounting a mast

In an embodiment, the upend deck with the cart track is located on the central axis of the vessel, and the crane is mounted away from the central axis of the vessel, e.g. along the side of the vessel. In such an embodiment, the cart track is thus not aligned with the slew axis of the upending crane. In such an embodiment, the wind turbine component is aligned with the central axis of the vessel during the upend process. In a further embodiment, the gripper is located on the central axis of the vessel as well, and the wind turbine can be moved into the gripper without substantially deviating from the center line of the vessel. The latter is allows for an efficient transfer of the wind turbine component from the upend location above the vessel to the installation location adjacent the vessel, i.e. outside the contour of the vessel.

In an alternative embodiment of an installation vessel according to the invention, the cart track is aligned with the slew axis of the crane, such that a central axis of the wind turbine components supported at one end by the cart and at an opposite end coupled with the trolley, or more in particular coupled with the load coupling device, is aligned with the slew axis of the upending crane. Thus, the weight of the wind turbine components is optimally transferred to the crane during the upending process.

In a further embodiment, at least part of the storage deck is aligned with a central longitudinal axis of the vessel, such that a wind turbine components can be stored on the storage deck on the centerline of the vessel. In such an embodiment, the upend deck is adjacent the central longitudinal axis of the vessel, and a wind turbine components supported on the upend deck is not located above the central longitudinal axis of the vessel.

In an embodiment, the gripper is a monopile gripper, and is located at the stern of the vessel and on the central longitudinal axis of the vessel. This is in particular beneficial when the hull of the vessel has an elongate shape. When the gripper is located on the center line of the vessel, transfer of the wind turbine component to the installation site, in particular landing the monopile on the seafloor or the mast on a foundation, does not cause a major shift in balance of the vessel, and therefore does not require the use of active ballast to compensate for roll of the vessel.

In an embodiment, the gripper is x-y compensated, i.e. is configured to position a wind turbine component, supported by the upend crane in an upended, i.e. upright, position, in the X-Y plane, and thus compensate for movement of the vessel relative to wind turbine component installation location.

In an embodiment, the trolley is an x-y compensated trolley, i.e. is configured to position the top of the wind turbine component, supported in the upended position, in the X-Y plane, and thus compensate for movement of the vessel relative to wind turbine component installation location.

For example, in an embodiment, an active horizontal motion device is mounted between the trolley and the load coupling device, when received in the trolley, and/or a wind turbine component engagement device supported by the load coupling device, the active horizontal motion device being adapted to actively compensate for sea-state induced horizontal displacement of the monopile engagement device in two non-parallel horizontal directions, e.g. in orthogonal horizontal directions, while the wind turbine component is supported in an upright position by the wind turbine component engagement device.

In a further embodiment, the active horizontal motion device comprises one or more motor powered displacement actuator assemblies, e.g. a hydraulic power assembly including a pump and one or more hydraulic cylinders or a winch assembly.

In a further embodiment, the active horizontal motion device is connected to a horizontal motion device linked to the gripper, for moving the load coupling device and/or the wind turbine component engagement device in dependence of movement of the gripper. For example, a control device can be provided that controls both the horizontal motion device of the trolley and the horizontal motion device of the gripper.

In an embodiment, the vessel comprises a recess at the aft of the vessel, the recess being flanked by two deck portions. In a further embodiment, the gripper is a mono pile gripper configured to guide a monopile that is supported in the recess by the upend crane. In yet a further embodiment, the monopile gripper is mounted on one of the deck portions and the upend crane is mounted on the opposite deck portion.

In an embodiment, the upend deck is provided on the central axis of the vessel, and is aligned with the recess, and on opposite sides of the upend deck a storage deck is provided, the storage decks being aligned with the deck portions, and the storage deck aligned with the deck portion on which the crane is mounted, is provided with storage for wind turbine blades.

In an embodiment, the vessel is provided with a wind turbine assembly station at an end of the upend deck and adjacent the upend crane, for assembling a wind turbine, i.e. for mounting a nacelle on a mast and for providing the nacelle with blades,

In an embodiment, the crane comprises a blade installer device, which blade installer device can be mounted to the trolley, for supporting wind turbine blade and for positioning the blade relative to a nacelle mounted on a mast supported in a wind turbine assembly station adjacent the upend crane.

In a further embodiment, the blade installer device comprises:
a base configured to be mounted to the trolley, or to be integrated with a dedicated trolley;
a connector, wherein the connector is configured for engaging a wind turbine blade, or for engaging a blade support that is removably mounted on the blade;
a pivot arm, which is at a base end is connected to the base for, in use, pivoting about a vertical axis, and is at an opposite end connected to the connector for, in use, pivoting about a vertical axis.

In an embodiment, the trolley is configured for supporting an assembled wind turbine, and the upend crane is provided with a second trolley, for engaging the mast of the assembled wind turbine at a lower end thereof, to stabilise the assembled wind turbine when supported by the upend crane.

In an embodiment, the gripper is a foundation gripper, configured to engage a floating foundation, to position the floating foundation in the horizontal plane relative to the vessel and/or to stabilise the floating foundation relative to the vessel.

In an embodiment, the gripper is a monopile gripper, configured for guiding a monopile that is being lowered adjacent the vessel using the upend crane.

In an embodiment, the vessel comprises a foundation gripper and a monopile gripper, preferably the pile gripper is integrated in the foundation gripper.

In an embodiment, the crane further comprises a crane tower for supporting a wind turbine component, e.g. a monopile, on a side of the crane opposite the side at which the boom is supported. For example, the crane tower can be used for supporting a monopile in the gripper and for lowering the monopile in a vertical position into the water adjacent the vessel, while upending a mast using the boom of the upend crane.

The crane tower extends between a base end and a top end, and is mounted in a fixed and upright position on the crane housing for rotation with the boom of the crane about the vertical slew axis, wherein the crane tower is provided with
a support trolley, configured to support a wind turbine component at the top end thereof;
a trolley guide, e.g. a track comprising one or more guide rails, for guiding the trolley along the crane tower;
a hoisting winch and an associated hoisting wire, wherein the hoisting wire is guided via the top of the crane tower for hoisting the trolley along the trolley guide, e.g. for lowering a monopile towards the seafloor.

In an embodiment, the crane, e.g. the crane housing and/or the boom of the crane is/are, provided with wind turbine component securing arms or tuggers for engaging a lower section of a wind turbine component supported by the crane in a vertical position, in particular for preventing sway of the wind turbine component during slewing of the crane while supporting the wind turbine component in the vertical position. Thus the crane can also be used for moving the wind turbine component from one location to another location, for example from an onboard location to an overboard location for installation of the wind turbine component at the installation site, for example for mounting the mast of an assembled wind turbine onto a foundation.

In an embodiment, the upend hoisting wire is, or wires are, passed between the upper sheave assembly and the lower sheave assembly, and wherein the hoisting wire or wires are connected to hoist winches of the crane, the winches having a capacity sufficient to lift the wind turbine component, e.g. to lift an assembled wind turbine or a foundation pile.

In an embodiment, the boom comprises a jib, and wherein the upper sheave assembly is provided in the jib such that the hoisting wire, when the load coupling device is received in the trolley, is positioned away from the boom, and is positioned at the position of a central axis of a wind turbine component supported in a vertical position by the trolley.

In an embodiment, the boom is an A-frame, comprising two legs, and wherein the trolley guide is provided on both legs.

In an embodiment, the boom comprises a jib, and wherein the upper sheave assembly is provided in the jib such that the hoisting wire, when the load coupling device is received in the trolley, is positioned away from the boom. In such an embodiment, the hoisting wire, or more in particular the section of the hoisting wire that is luffed between the upper sheave assembly and the lower sheave assembly, is aligned with the wind turbine component supported by the crane in the vertical position. This configuration makes that the trolley is not subjected moment forces caused by the weight of the wind turbine component.

In a further embodiment, the part of the hoisting wire that extends between the trolley and the upper sheave assembly runs parallel to the trolley guide.

In an embodiment, the boom at the base end comprises a gantry, and at the top end comprises a gantry jib, and is provided with one or more gantry wires extending between the gantry and the gantry jib, and wherein the luffing wire extending between the luffing winch and the boom, more in particular extending between the luffing winch and the gantry of the boom. This configuration reduces bending forces in the A-frame of the boom, in particular when the boom also comprises a jib for spacing the hoisting wire from the boom.

The invention furthermore provides a method for upending a wind turbine component, preferably using a installation vessel according to the invention, the method comprising the steps:
lifting a wind turbine component, e.g. a monopile, in a horizontal position onto the upend deck, using the crane with the boom in the lowered hoisting position for lifting one end of the monopile and a hoisting crane lifting an opposite end of the monopile;
moving the boom from the lowered hoisting position into the raised upending position;
engaging the wind turbine with the wind turbine engagement device, e.g. a monopile wind turbine engagement device;
upending the wind turbine component using the crane with the boom in the upending position for lifting one end of the wind turbine component by moving the trolley along the boom from a lowered coupling position to a raised support position.

In a further method according to the invention the wind turbine component is a monopile and the gripper is a monopile gripper, and the method further comprises the steps:
after upending, moving the pile from an upend location above the upend deck to an installation location, in which installation location the monopile is aligned with the monopile gripper, by slewing the crane about the vertical slew axis, over a slew angle of at least 180 degrees, preferably over a slew bearing angle of more than 180 degrees, e.g. over an slew angle of 190 degrees, moving the monopile from the upend deck over the side of the vessel, and subsequently towards a monopile gripper mounted to the rear end of the hull of the vessel.

The invention furthermore provides a crane, the crane to be supported by the hull of a vessel adjacent an upend deck for upending and installation of wind turbine components for supporting a wind turbine, wherein the crane comprises:
a crane base to be supported by the hull of the vessel;
a crane housing;
a slew bearing, provided between the crane housing and the crane base, the slew bearing enabling the crane housing to slew about a vertical slew axis;
a boom, extending between a base end and a top end, wherein the boom is at the base end pivotable supported by the crane housing for pivoting about a horizontal boom pivot axis between a lowered hoisting position and a raised upend position for upending wind turbine components;
a luffing winch and an associated luffing wire, wherein the luffing winch is mounted on the crane housing and the luffing wire extends between the luffing winch and the boom, to enable pivoting the boom between the lowered and a raised position;
a trolley, provided with a wind turbine component engagement device that is configured to pivotably support a wind turbine component at the top end thereof;
a trolley guide, e.g. a track comprising one or more guide rails, for guiding the trolley along the boom, wherein the trolley guide comprises a boom section that is mounted to the boom of the crane, and a base section that is mounted to the base of the crane, and wherein the trolley can be received on the base section of the trolley guide, to allow for operation of the boom without the trolley;
a hoisting winch and an associated hoisting wire, wherein the hoisting wire is guided via the boom and supports a load coupling device configured to be connected to a load and preferably to be connected to the trolley for hoisting the trolley along the trolley guide between a lowered coupling position, for coupling the load coupling device with the top end of the pile located in a horizontal position on the upend deck, and a raised support position, for supporting the wind turbine component in a vertical position.

The invention furthermore provides a crane, the crane to be supported by the hull of a vessel adjacent an upend deck for upending and installation of wind turbine components for supporting a wind turbine, wherein the crane comprises:
a crane base to be supported by the hull of the vessel;
a crane housing;
a slew bearing, provided between the crane housing and the crane base, the slew bearing enabling the crane housing to slew about a vertical slew axis;
a boom, extending between a base end and a top end, wherein the boom is at the base end pivotable supported by the crane housing for pivoting about a horizontal boom pivot axis between a lowered hoisting position for lifting a load at a distance from the crane base and a raised upend position for upending wind turbine components adjacent the crane base;
a luffing winch and an associated luffing wire, wherein the luffing winch is mounted on the crane housing and the luffing wire extends between the luffing winch and the boom, to enable pivoting the boom between the lowered and the raised position;
a trolley, provided with a wind turbine component engagement device that is configured to pivotably support a wind turbine component at the top end thereof or configured to receive the wind turbine component engagement device and/or the load coupling de vice supporting the wind turbine component engagement device;
a trolley guide, e.g. a track comprising one or more guide rails, for guiding the trolley along the boom;
a hoisting winch and an associated hoisting wire, wherein the hoisting wire is guided via the top end of the wire and supports the load coupling device configured to be connected to a load and preferably to the trolley for hoisting the trolley along the trolley guide between a lowered coupling position, for coupling the trolley with the top end of the pile located in a horizontal position on the upend deck, and a raised support position, for supporting the wind turbine component in a vertical position;
preferably an active horizontal motion device that is mounted between the trolley on one side and the load coupling device and/or wind turbine component engagement device on the other side, the active horizontal motion device being adapted to actively compensate for sea-state induced horizontal displacement of the wind turbine component engagement device in two non-parallel horizontal directions, e.g. in orthogonal horizontal directions, while the wind turbine component is supported in an upright position by the wind turbine component engagement device.

In a further embodiment, the active horizontal motion device is connected to a horizontal motion device linked to the wind turbine component gripper, for moving the load coupling device and/or the wind turbine component engagement device in dependence of movement of the wind turbine component gripper.

The invention furthermore provides an installation vessel, for installation and preferably transport of monopiles and wind turbines, the vessel comprising:
a hull, the hull forming an upend deck,
a crane, supported by the hull of the vessel adjacent the upend deck, wherein the crane comprises:
a crane base,
a crane housing and a slew bearing provided between the crane base and the crane housing, wherein the slew bearing enables the crane housing to slew about a vertical slew axis;
a boom, wherein the boom extends between a base end and a top end, wherein the boom is at the base end pivotable supported by the crane housing for lifting a load at a distance from the crane base and a raised upend position for upending wind turbine components adjacent the crane base;
a luffing winch and an associated luffing wire, wherein the luffing winch is mounted on the crane housing and the luffing wire extends between the luffing winch and the boom, to enable pivoting the boom between the lowered and the raised upend position; and
a hoist, wherein the hoist comprises a hoisting winch and an associated hoisting wire, wherein the hoisting wire is guided via an upper sheave assembly in the boom to a lower sheave assembly of the load coupling device for coupling with a load, e.g. a top end of a wind turbine component, to enable the crane to lift the load using the hoisting winch;
a trolley guide, e.g. a track comprising one or more guide rails, mounted to the boom of the crane; and
a trolley, wherein the trolley is provided with a wind turbine component engagement device that is configured to pivotably support a wind turbine component at the top end thereof, or wherein the trolley is configured to receive a wind turbine component engagement device and/or a load coupling device supporting a wind turbine component engagement device.
a cart track, extending along the upend deck;
a support cart for supporting a bottom end of the wind turbine component, wherein the support cart is supported by the cart track to enable the cart to move along the cart track for guiding the bottom end of the wind turbine component along the upend deck from a position distal form the crane to a position adjacent the crane; and
a gripper, the gripper extending outside a contour of the vessel, e.g. for guiding a monopile being lowered in a vertical position into the water adjacent the vessel or for engaging, and preferably stabilising, a floating foundation for mounting a mast, wherein the trolley is coupled with the trolley guide for being guided along the boom of the crane, for guiding the top end of the wind turbine component along the trolley guide while upending the monopile while the bottom end of the wind turbine component is guided by the cart and the upend track.

In an embodiment, the crane further comprises a crane tower for supporting a wind turbine component on a side of the crane opposite the boom, e.g. for supporting a monopile in the monopile gripper and for lowering the monopile in a vertical position into the water adjacent the vessel, wherein the crane tower extends between a base end and a top end, and is mounted in a fixed and upright position on the crane housing for rotation with the boom of the crane about the vertical slew axis, wherein the crane tower is provided with a
an support trolley, configured to support a wind turbine component at the top end thereof;
a trolley guide, e.g. a track comprising one or more guide rails, for guiding the trolley along the crane tower;
a hoisting winch and an associated hoisting wire, wherein the hoisting wire is guided via the top of the crane tower for hoisting the trolley along the trolley guide for lifting and lowering the wind turbine component.

The invention furthermore provides a crane for providing an installation vessel according to the invention.

Herein, wind turbine component may refer to a pile, or a foundation pile, for supporting the mast of a wind turbine, or to a mast, for supporting the nacelle of a wind turbine.

The invention furthermore provides an installation vessel, for installation and preferably transport of wind turbine components, e.g. monopiles or masts, the installation vessel comprising:
a hull, the hull forming an upend deck,
a crane, supported by the hull of the vessel adjacent the upend deck, wherein the crane comprises:
a crane base, a crane housing and a slew bearing provided between the crane housing and the crane base, the slew bearing enabling the crane housing to slew about a vertical slew axis;
a boom, extending between a base end and a top end, wherein the boom is at the base end pivotable supported by the crane housing for pivoting about a horizontal boom pivot axis between a lowered position and a raised position for lifting a load and for moving that load towards or away from the crane base;
a luffing winch and an associated luffing wire, wherein the luffing winch is mounted on the crane housing and the luffing wire extends between the luffing winch and the boom, to enable pivoting the boom between the lowered and the raised position; and
a hoist, the hoist comprising a hoisting winch and an associated hoisting wire, wherein the hoisting wire is guided via an upper sheave assembly in the boom to a lower sheave assembly of the load coupling device for coupling with a load, e.g. the top end of a wind turbine component, to enable the crane to lift the load using the hoisting winch;
a cart track, extending along the upend deck;
a support cart for supporting a bottom end of the wind turbine component, wherein the support cart is supported by the cart track to enable the cart to move along the cart track for guiding the bottom end of the wind turbine component along the upend deck from a position distal form the crane to a position adjacent the crane;
a gripper, the gripper extending outside a contour of the vessel, e.g. for guiding a monopile being lowered in a vertical position into the water adjacent the vessel or for engaging a foundation for mounting a mast;
a trolley guide, e.g. a track comprising one or more guide rails, mounted to the boom of the crane; and
a trolley, coupled with the trolley guide for being guided along the boom of the crane, wherein the trolley is configured to engage the load coupling device for guiding the load coupling device, and thus for guiding the top end of the wind turbine component supported by the load coupling device, along the trolley guide while upending the wind turbine component using the hoist,
wherein the boom of the crane can be pivoted in an upend position for upending the wind turbine component with the bottom end of the wind turbine component being guided by the cart and the upend track and with the top end of the wind turbine component being guided by the trolley and the trolley guide, and preferably wherein the vessel further comprises boom securing device, the boom securing device comprising a stop for positioning the boom in the upend position, and a boom locking device, for securing or locking the boom in the upend position and/or a boom mobiliser, for moving the boom out of the upend position and away from the boom securing device, e.g. a hydraulic cylinder for pushing the boom away from the upend position, or a winch with association wire for pulling the boom away from the upend position.

The invention furthermore provides an installation vessel, for installation and preferably transport of monopiles for supporting a wind turbine, the installation vessel comprising:
a hull, the hull forming an upend deck,
a crane, supported by the hull of the vessel adjacent the upend deck, wherein the crane comprises:
a crane base, a crane housing and a slew bearing provided between the crane housing and the crane base, the slew bearing enabling the crane housing to slew about a vertical slew axis;
a boom, extending between a base end and a top end, wherein the boom is at the base end pivotable supported by the crane housing for pivoting about a horizontal boom pivot axis between a lowered position and a raised position for lifting a load and for moving that load towards or away from the crane base;
a luffing winch and an associated luffing wire, wherein the luffing winch is mounted on the crane housing and the luffing wire extends between the luffing winch and the boom, to enable pivoting the boom between the lowered and the raised position; and
a hoist, the hoist comprising a hoisting winch and an associated hoisting wire, wherein the hoisting wire is guided via a top block to a load coupling device, or via an upper sheave assembly in the boom to a lower sheave assembly of the load coupling device respectively, for coupling with a load, e.g. the top end of a monopile, to enable the crane to lift the load using the hoisting winch;
a cart track, extending along the upend deck;
a support cart for supporting a bottom end of the monopile, wherein the support cart is supported by the cart track to enable the cart to move along the cart track for guiding the bottom end of the monopile along the upend deck from a position distal form the crane to a position adjacent the crane;
a monopile gripper, the monopile gripper extending outside a contour of the vessel, for guiding a monopile being lowered in a vertical position into the water adjacent the vessel;
a trolley guide, e.g. a track comprising one or more guide rails, mounted to the boom of the crane; and
a trolley, coupled with the trolley guide for being guided along the boom of the crane, wherein the trolley is configured to engage the load coupling device for guiding the load coupling device, and thus for guiding the top end of the monopile supported by the load coupling device, along the trolley guide while upending the monopile using the hoist, wherein the boom of the crane can be pivoted in an upend position for upending the monopile with the bottom end of the monopile being guided by the cart and the upend track and with the top end of the monopile being guided by the trolley and the trolley guide.

Herein, adjacent the crane is considered within reach of the crane when the boom of the crane is in the raised upend position.

In an embodiment, an active horizontal motion device is mounted between the trolley and the load coupling device, when received in the trolley, and/or a wind turbine component engagement device supported by the load coupling device, the active horizontal motion device being adapted to actively compensate for sea-state induced horizontal displacement of the wind turbine component engagement device in two non-parallel horizontal directions, e.g. in orthogonal horizontal directions, while the wind turbine component is supported in an upright position by the wind turbine component engagement device.

In a further embodiment, the active horizontal motion device comprises one or more motor powered displacement actuator assemblies, e.g. a hydraulic power assembly including a pump and one or more hydraulic cylinders or a winch assembly.

In an embodiment, a vessel according to the claimed invention is provided with a cart track, and a support cart, wherein the support cart is configured for supporting a bottom end of the wind turbine component, for guiding the bottom end of the wind turbine component along the upend deck. Thus, the cart track is configured to engage the bottom end of the wind turbine component.

In an embodiment, the support cart comprises a cart base, that is movable supported on the cart track, and a wind turbine component engagement device, that is configured to engage the bottom end of the wind turbine component. Preferably, the wind turbine component engagement device is pivotable supported by the cart base, such that the wind turbine engagement device can pivot with the wind turbine component during the upending. For example, the cart may comprise a cradle for supporting the bottom end of a foundation pile, or may comprise an insert to be inserted into the bottom end of a foundation pile, to engage the bottom end of a foundation pile at the inside. In such an embodiment, the cradle or insert is pivotable supported by the cart base.

In an embodiment, the upend crane is mounted on a vessel and is located relative to the storage deck, such that the center of gravity of piles stored on the storage deck lies within the reach of the upend crane. Thus, the upend crane is positioned to lift wind turbine components, e.g. foundation piles, in a horizontal position from the storage deck onto the upend deck. In a further embodiment, the upend crane can furthermore be used to lift a wind turbine components from a supply vessel or from the quay onto the storage deck.

In such an embodiment, because the upend crane can be used for lifting piles onto the vessel, i.e. lifting piles in a horizontal position, there is no need for a second crane, e.g. a storage crane, for loading piles. Also, the upend crane can thus be used for lifting piles from a storage position into an upend position.

Also, in an embodiment, the base guide section of the trolley guide extends along the base of the crane and/or along part of the hull supporting the crane, down to a deck, e.g. a submersible deck. In an embodiment, the trolley can be parked on the base guide section of the trolley guide. When the trolley is parked on the base guide section, the boom of the crane can be operated without it supporting the trolley. This is in particular beneficial when the crane is to be used to lifting a load, and not for upending a wind turbine component. In addition or as an alternative, the base guide and the trolley may be configured such that the trolley can be landed on the upend deck, and can be disconnected from the base guide, such that it can be stored on the upend deck, or on another deck, away from the base guide. In an embodiment, the trolley is configured to be moved along the cart track.

An upend crane according to the invention may also be combined with a semi-submersible or heavy lift type vessel. In an embodiment, the ship is a monohull semi-submersible vessel, or heavy lift vessel, provided with an elongated hull supporting a lowered submersible deck, i.e. a deck that is recessed in the hull structure. By flooding and emptying ballast tanks, the heavy lift vessel can be moved between a raised transport position, in which the submersible deck is above the water surface, and a lowered, or semi submersed, position in which the submersible deck is submersed, i.e. is below the water surface.

Thus, such a heavy lift vessel comprises one or more hull sections that extend upwards from the submersible deck. These hull sections support the pilot house of the vessel, the crew quarters, the crane, a second deck, etc.

In an embodiment, the hull of the heavy lift vessel comprises a bow section that supports a crane, and a submersible that deck extends from the bow section of the hull towards the rear of the vessel. Such a vessel is for example disclosed in publications WO2019245374 and WO2021245175. In these embodiments, the base of the crane is supported on the bow section of the hull of the vessel. The hull vertically below the vessel comprises a crane support structure.

In an embodiment, an upend crane according to the invention is provided on a heavy lift vessel, wherein the heavy lift vessel comprises a bow section and a submersible deck, wherein the submersible deck is recessed relative to the bow section and extends from the bow section towards the rear of the vessel. In such an embodiment, the crane is located on the bow section, adjacent the submersible deck and adjacent a side of the vessel. The upend crane is thus supported by the bow section, i.e. a section of the hull that extends above the submersible deck of the vessel.

In this embodiment, the submersible deck of the heavy lift vessel comprises the upend deck and preferably the storage deck.

The upend deck, i.e. the section of the submersible deck for upending, is provided with a cart track and a support cart for guiding a bottom end of a mast or monopile during the upend process. The cart track extends along the upend section of the submersible deck, parallel to a longitudinal axis of the vessel, between a track end distal from the crane and a track end adjacent the upend crane, and thus adjacent the bow section of the vessel supporting the upend crane.

The storage deck, i.e. the section of the submersible deck for storage of wind turbine components, is provided with storage racks for supporting multiple monopiles or masts in a horizontal position. The storage deck is located adjacent the upend deck, and the wind turbine components are stored on the storage deck parallel to the cart track, and thus parallel to the longitudinal axis of the vessel. This facilitates moving the wind turbine components from the storage deck to the upend deck an onto the cart track, because the orientation of the wind turbine components does not have to be changed when they are lifted from the storage deck onto upend deck.

In this embodiment, the upend crane has a the trolley guide that comprises a boom section that is mounted to the boom of the crane, and a base section that is mounted to the base of the crane. In such an embodiment, the trolley guide extends along the boom of the crane and below the boom of the crane, i.e. below the horizontal boom pivot axis, when the boom is in the upend position. Thus, the trolley can be moved along the boom of the crane, and can be lowered below the boom of the crane, when the boom is in the upend position. Extending the trolley guide below the boom pivot axis allows for lowering the trolley below the boom pivot axis.

In this embodiment, the base section of the trolley guide is provided on the side of the crane base that faces the submersible deck of the vessel. The base section of the trolley guide furthermore extends from the crane base, that is supported on the bow section of the hull, along part of the bow section that faces the submersible deck, downwards towards the submersible deck. Thus extending the trolley guide allows for lowering the trolley closer to the upend deck, i.e. to the submersible deck that is recessed relative to the bow section.

In this embodiment the base section of the trolley guide is mounted to the base of the crane and to the part of the hull of the vessel, and does not pivot with the boom and the trolley guide connected to the boom, when the upend crane is rotated about the vertical slew axis.

In a further embodiment, the submersible deck, more in particular the upend section of the submersible deck, is provided with a cart track to enable guiding the lower end of a wind turbine component, e.g. a foundation pile, with a cart, during upending.

In this embodiment, the base section of the trolley guide is aligned with the cart track on the submersible deck, such that it can be used to lower the trolley in a position close to the deck and in alignment with the cart track. Thus, the trolley can be lowered from the boom section onto the base section and into a position close to the upend deck in alignment with the cart track. This allows for example guiding a wind turbine component engagement device and/or a load coupling device supporting a wind turbine component engagement device in a position close to the deck to enable coupling with the top end of the monopile.

In an embodiment, the heavy lift vessel is provided with a gripper for guiding a monopile being lowered in a vertical position into the water adjacent the vessel using the upend crane.

In a further embodiment, the pile gripper is supported adjacent the upend deck, i.e. adjacent the semi-submersible deck of the vessel, at the end of the deck at the bow section.

In such an embodiment, the pile gripper may be mounted to the side of the vessel, i.e. to a vertical section of the hull, adjacent the upend deck and at the end of the upend track.

In an alternative embodiment, the pile gripper comprises a pile gripper support construction that is mounted on the upend deck, at the end of the upend deck. In such an embodiment, the pile gripper support construction may be mounted on the end of the upend track, or cart track. As an alternative, the upend track ends before the pile gripper support. In such an embodiment, the semisubmersible deck comprises a pile gripper set up area between the end of the upend track and the bow section, and thus between the upend track and the base of the upend crane, when seen in top view.

In such an embodiment, the support cart for supporting a bottom end of the wind turbine component, e.g. a foundation pile, is configured to hold the bottom end of the wind turbine component at a height above the semi-submersible deck, such that it can hold the bottom end of the wind turbine component while it is supported by the upend crane above the pile gripper support construction.

For example, the support cart may comprise a cart base, that is movable supported on the cart track, and a wind turbine component engagement device, that is configured to engage the bottom end of the wind turbine component, wherein the wind turbine component engagement device is pivotable supported by the cart base. In such an embodiment, the cart base has the pivot axis at a height above the pile gripper, or at least the pile gripper support construction, such that when the wind turbine component is upended, i.e. is pivoted in the upright position, the bottom surface of the wind turbine component is at a height above the pile gripper, or at least the pile gripper support construction.

Furthermore, the pivot axis is preferably at a height, when the wind turbine component prior to upending is in a horizontal configuration, that is larger than the width of the wind turbine component, such that, when the wind turbine component is upended, i.e. is pivoted in the upright position, the wind turbine component is adjacent the pivot axis. Thus, the support cart can be moved next to the pile gripper support construction, with the wind turbine component engagement device engaging the wind turbine component, while the wind turbine component is supported by the upend crane above the pile gripper support construction.

In addition or as an alternative, the support cart is configured to guide the bottom end of the wind turbine component in a vertical direction.

In an embodiment, the base of the crane is provided with an additional trolley guide base section, provided on the side of the crane base that faces the side of the vessel. The additional trolley guide base section extends from the crane base, supported on the bow section of the hull, along part of the bow section of the hull at the side of the vessel. Thus, the trolley can be lowered from the boom section onto the additional base section, optionally via an intermediate section, into a position close to the water surface. This allows for example guiding a wind turbine component engagement device and/or a load coupling device supporting a wind turbine component engagement device in a position close to a pile guide supported at the side of the vessel, below the additional trolley guide base section.

The trolley guide base section and the additional trolley guide base section can be aligned with the trolley guide boom section by slewing the crane house in the correct position. In an embodiment, the crane house is to be slewn over an angle of 90 degrees to move the trolley guide boom section from a position in which the trolley guide boom section is aligned with the trolley guide boom section and a position in which the trolley guide boom section is aligned with the additional trolley guide boom section

In an embodiment, the heavy lift vessel is provided with a gripper for guiding a monopile being lowered in a vertical position into the water adjacent the vessel using the upend crane.

In a further embodiment, the vessel is configured to support the pile gripper adjacent the bow section of the vessel, and adjacent the crane preferably near the water surface. In such an embodiment, the upend crane can move an upended pile from the submersible deck into, or above, the pile gripper by slewing over a 90 degree angle.

In an embodiment, the vessel is provided with mounts, e.g. mounts secured to parts of the hull configured to support the upend crane, for supporting the gripper. In such an embodiment, the gripper preferably is configured to be hoisted into position using the upend crane. Thus the upend crane can be used for moving the gripper between a storage position, for example for when the vessel is to enter a harbour, and the mounted position, for guiding a pile adjacent the vessel.

In an alternative embodiment, the vessel is provided with a gripper support construction that is configured to transfer the gripper from a position on the submersible deck to a position adjacent the vessel for guiding a pile. In a further embodiment, the gripper support construction is configured to at least partially support the pile gripper in a position for guiding a pile adjacent the vessel.

In an alternative embodiment, the heavy lift vessel is provided with a pile gripper for guiding a pile adjacent the submersible vessel, near the bow section, at the end of the upend track. In such an embodiment, the pile gripper preferably comprises a pile gripper support construction that is configured to move the pile gripper between a storage position at one side of the upend track, to enable the upend crane to upend a foundation pile, and a position on the opposite side of the upend track and adjacent the vessel for guiding the upended pile.

In an embodiment, the gripper is x-y compensated, i.e. is configured to position a wind turbine component, supported by the upend crane in an upended, i.e. upright, position, in the X-Y plane, and thus compensate for movement of the vessel relative to wind turbine component installation location. Preferably, the gripper comprises a gripper support construction configured to support the gripper adjacent the vessel in a position for guiding a pile, and for providing the gripper with x-y compensation in that position.

In an embodiment, the gripper is x-y compensated, for example is configured to position a monopile, supported in an upright position, in the X-Y plane, and thus is configured to compensate for movement of the vessel relative to monopile installation location.

The invention furthermore provides a monohull vessel provided with a an upend crane according to the invention, wherein the vessel comprises an elongated hull extending between a bow and an aft of the vessel, the elongated hull having a bow section that supports the crane and pilot housing, wherein the elongated hull supports a submersible deck that extends from the bow section towards the aft of the vessel, and which submersible deck is recessed in the hull structure relative to the bow section, such that the bow section has a vertical hull surface facing towards the submersible deck and the aft of the vessel, wherein the submersible deck comprises an upend deck that is provided with a cart track and a support cart for guiding a bottom end of a pile, the cart track extending parallel to a longitudinal axis of the vessel between a track end distal from the bow section and a track end adjacent the bow section, wherein the submersible deck of the heavy lift vessel comprises a storage deck adjacent the upend deck, wherein the storage deck is provided with storage racks for supporting multiple piles in a horizontal position parallel to the cart track, and thus parallel to the longitudinal axis of the vessel, wherein the upend crane is supported by the bow section of the hull, adjacent the submersible deck and adjacent a side of the vessel, and wherein the trolley guide of the crane comprises a boom section that is mounted to the boom of the crane, and a base section that is mounted to the base of the crane, wherein the base section of the trolley guide is provided on the side of the crane base that faces the submersible deck of the vessel, and wherein the base section of the trolley guide extends from the crane base, supported on the bow section of the hull, along the vertical hull surface of the bow section that faces the submersible deck, such that a trolley can be lowered along that vertical hull surface towards the submersible deck.

In an embodiment, the bow section furthermore supports a deck, for example for storing transition pieces, a demountable gripper ring when not in use, etc.

In an embodiment, the upend crane is provided with stabilizer arms, preferably located at the lower end of the boom and/or on the crane housing, for engaging a wind turbine component supported by the upend crane, to stabilize the wind turbine component while the crane is pivoted about its pivot axis. In an embodiment, the stabilizer arms are provided with magnets for engaging the wind turbine component. In an alternative embodiment, the stabilizer arms can be pivoted between an inactive upright position, in which they extend along the boom of the crane, and an active horizontal position in which they extend from the boom of the crane at opposite sides of the wind turbine component, to hold the wind turbine component between them.

Herein the X-Y plane of a vessel has an X-direction, which as is known in the art corresponds to the longitudinal direction of the vessel, and a Y-direction corresponding to the transverse direction of the vessel and perpendicular to the X-direction. The X-Y plane is spanned by the X- and Y-directions. The vessel also has a Z-direction perpendicular to the X-Y plane. Thus, when the vessel floats in equilibrium on perfectly flat water, the X-Y plane is horizontal and the Z-direction is vertical.

In an embodiment, an active horizontal motion device is mounted between the trolley and the load coupling device, when received in the trolley, and/or a wind turbine component engagement device supported by the load coupling device, the active horizontal motion device being adapted to actively compensate for sea-state induced horizontal displacement of the load coupling device relative to an installation location in two non-parallel horizontal directions, e.g. in orthogonal horizontal directions, while the wind turbine component is supported in an upright position by the wind turbine component engagement device. In a further embodiment, the horizontal motion device is configured to, when not compensating for sea-state induced horizontal displacement, enable horizontally positioning the load coupling device. For example, the horizontal motion device can thus be used to move the load coupling device in a radial direction relative to the boom, when the boom is in the upend position. This allows for adjusting the position of the load coupling device, for example to vertically align the load coupling device with a load on the deck of the vessel, without having to pivot the boom out of the upend position.

In an embodiment, the boom is at the base end via a horizontal boom pivot axis pivotable supported by the crane housing for lifting a load at a distance from the crane base and a raised upend position for upending wind turbine components adjacent the crane base.

In a further embodiment, the trolley comprises a first trolley part that is connected to the trolley guide, and a second trolley part that is hingeable connected to the first trolley part via a trolley hinge axis, and wherein the trolley hinge axis is parallel to the boom pivot axis, such that when the boom is pivoted about the boom pivot axis, the second part of the trolley can be pivot relative to the boom such that the second part keeps its orientation relative to the deck of the vessel. For example, in an embodiment, the trolley comprises an active horizontal motion device that is mounted between the trolley and a load coupling device that is received in the trolley, such that the active horizontal motion device can actively compensate for sea-state induced horizontal displacement of the load coupling device in two non-parallel horizontal directions, e.g. in orthogonal horizontal directions. Typically, the active horizontal motion device is configured to be able to compensate for sea-state induced horizontal displacement of the load coupling device when the boom is in the the raised upend position.

When the horizontal motion device is part of the second part of the trolley, the active horizontal motion device can be kept at the same orientation relative to the deck of the vessel by pivoting the second part of the trolley relative to the boom when the boom is pivoted relative to the base of the crane, for example is lowered towards the deck of the vessel. Thus, the horizontal motion device can be used to position the load coupling device when the boom is not at the upright position, for example is slightly pivoted outward to position the load coupling device above a pile gripper, for example align the load coupling device with a central axis of the gripper ring of the pile gripper.

In an embodiment the trolley comprises two support arms, the support arms, the arms extending in a direction away from the boom and being moveable relative to the trolley in a first direction, and the support arms supporting a yoke, which yoke is connected with the hoisting device or is connectable with a load connecting device supported by the hoisting device. In such an embodiment, the moveable arms and moveable yoke enable movement of the load connection device relative to the boom, more in particular in a plane perpendicular to the longitudinal axis of the boom.

In an embodiment, the support arms and yoke are part of an active horizontal motion device of the trolley.

In a further embodiment, the support arms are pivotable about a trolley pivot axis parallel to a boom pivot axis, to enable the to support arms to stay parallel to the deck surface when the boom is pivoted out of the upend position.

For example, the arms may each be provided with tracks extending along the arm, and the yoke may be configured to move along the tracks. Thus, the yoke is movably supported at opposite sides.

In an alternative embodiment, the arms are each mounted on a base, such that the arms and the base form a U-shaped configuration, and the base is movable supported by the trolley for movement in a direction for movement in a first direction, wherein the first direction is perpendicular to the second direction. Thus, yoke can be moved in both the first and in the second direction.

In such an embodiment, actuators are provided for moving the base relative to the trolley and actuators are provided for moving the yoke relative to the arms. Furthermore, a control system is provided that controls the actuators, and thus controls the movement of the yoke, which control system is preferably configured to compensate for sea induced movement of the vessel supporting the crane, more in particular is configured to prevent sea induced movement of the yoke relative to the sea floor and/or relative to a floating foundation or a mounting surface on a floating foundation.

In an embodiment, the control system is also linked to the hoisting device supporting the trolley, to control the hoisting device for providing the trolley with heave compensation, i.e. provide compensation for movement in the vertical direction.

In a further embodiment, the control system is provided with one or more sensors configured to detect movement of an object to be engaged by the load engagement device coupled with or supported by the yoke, and the control system is configured to move the ring with the object to be lifted, to thus enable the yoke to engage the object. With such an embodiment, for example the control system may actively move the yoke synchronous with the section of a wind turbine mast to be engaged by the load engagement device. Thus, the control system facilitates engaging the mast of a wind turbine mounted on a foundation, for example to lift the wind turbine form the foundation for maintenance and/or to replace the wind turbine with another wind turbine. This is in particular beneficial when the foundation is a floating foundation.

In an embodiment, the upend crane is provided with a jib, and the upend crane is configured to move the yoke, or move the hoisting wires with the yoke, along the arms by pivoting the Jib, thus adapting the distance between the hoisting wires extending between the jib and the load engagement device and the boom.

In an embodiment, the trolley is configured to allow for limited movement of a foundation pile relative to the trolley, and is furthermore configured to dampen that movement. Thus for example, roll of a vessel may cause a pile that is upended in a plane parallel to the longitudinal axis of the vessel to move in a direction substantially perpendicular to the longitudinal axis of the vessel, in particular may cause the top end of the foundation pile to rock in that direction while being upended. In such an embodiment the trolley may allow for some movement of the upper end of the foundation pile relative to the trolley, while dampening the movement at the same time. For example, when the trolley is provided with a an active horizontal motion device, that device may be used for allowing a rocking movement of the top end of the foundation pile in a direction perpendicular to the longitudinal axis of the vessel. In such an embodiment, the active horizontal motion device may furthermore be configured to dampen the movement, and/or the trolley may be provided with dampers to dampen the movement.

It is submitted that effect of roll of the vessel is more pronounced away from the longitudinal axis of the vessel. Therefore, in an embodiment the trolley is configured to allow for increased rocking movement of the load when the trolley is moved upwards, for example when upending a pile, and is configured to increasingly reduce the rocking movement when the trolley is lowered, for example while lowering the pile through the pile gripper.

In an embodiment, the ring of the pile gripper is pivotable, i.e. the ring can pivoat about a central vertical axis relative to a base of the pile gripper that is mounted to the vessel, such that the opening of the gripper ring can be directed towards a pile supported by the upend crane, and such that the wind turbine can be moved into the ring by a slewing movement of the upend crane. Furthermore, in such an embodiment the gripper ring can, once the wind turbine component is received in the gripper ring, pivot the gripper ring such that the opening faces away from the vessel, to enable the wind turbine component, e.g. a foundation pile driven into the sea floor, to be moved out of the gripper ring via the opening of the gripper ring by moving the vessel away, preferably in a lateral direction away, from the foundation pile.

In an embodiment, the track cart is provided with a cradle for receiving the lower end of the wind turbine component, e.g. of a foundation pile. In a preferred embodiment, the cradle can be adapted to fit wind turbine components of different cross sections. In addition or as an alternative the trolley is configured to allow for some movement of the cradle, and thus the bottom end of the wind turbine component supported by the cradle, for example to allow for rocking movement of the top of the wind turbine component supported by the trolley.

Advantageous embodiments of the upend crane and the installation vessel according to the invention and the method according to the invention are disclosed in the sub claims and in the description, in which the invention is further illustrated and elucidated on the basis of a number of exemplary embodiments, of which some are shown in the schematic drawing. In the figures, components corresponding in terms or construction and/or function are provided with the same last two digits of the reference numbers.

It will be appreciated by the skilled person that a technical feature discussed herein as required or as optional with respect to one embodiment of the invention may be equally applicable to one or more other embodiments described herein, with the feature performing its designation function. Such combinations are all envisaged herein unless a combination would result in a technical impossible solution and/or not meet the desired functionality.

### BRIEF DESCRIPTION OF THE DRAWINGS

### In the Figures:

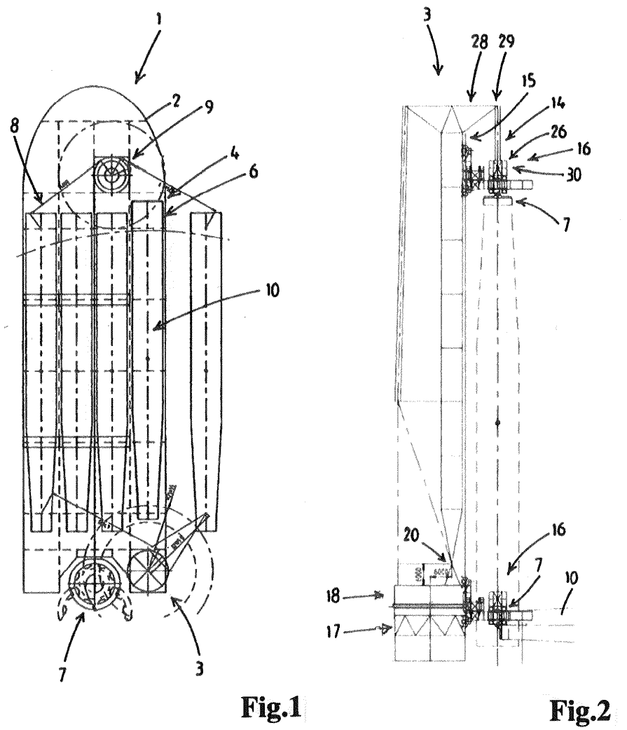

FIG. 1 shows a schematic top view of an exemplary embodiment of an installation vessel according to the invention wherein the vessel is provided with an upend crane and an upend deck that is aligned with a slew axis of the crane;

FIG. 2 shows a schematic side view of a crane according to the invention, with a boom in an upend position and a trolley depicted in a first and a second position;

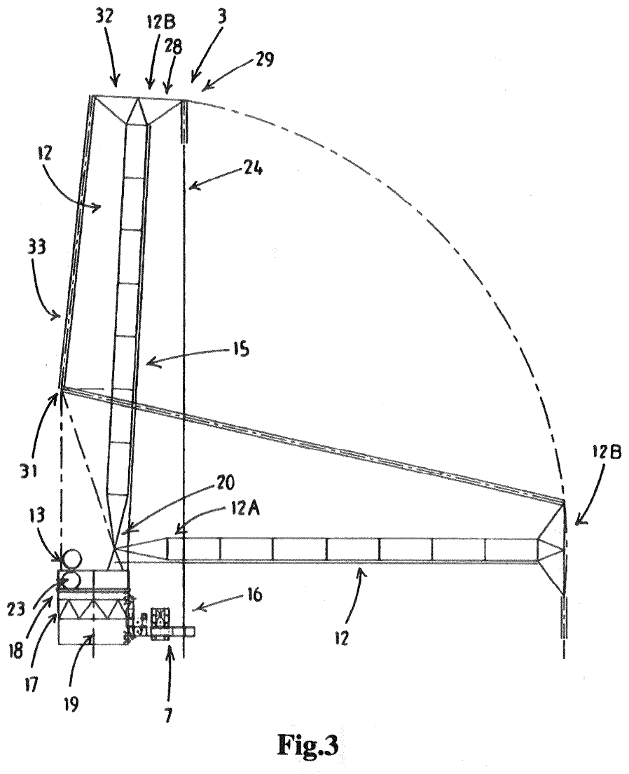

FIG. 3 shows a schematic side view of the crane of FIG. 2 with the boom of the crane in the upend position and in a lowered position, and with a trolley parked on a section of the trolley guide located on a base of the crane;

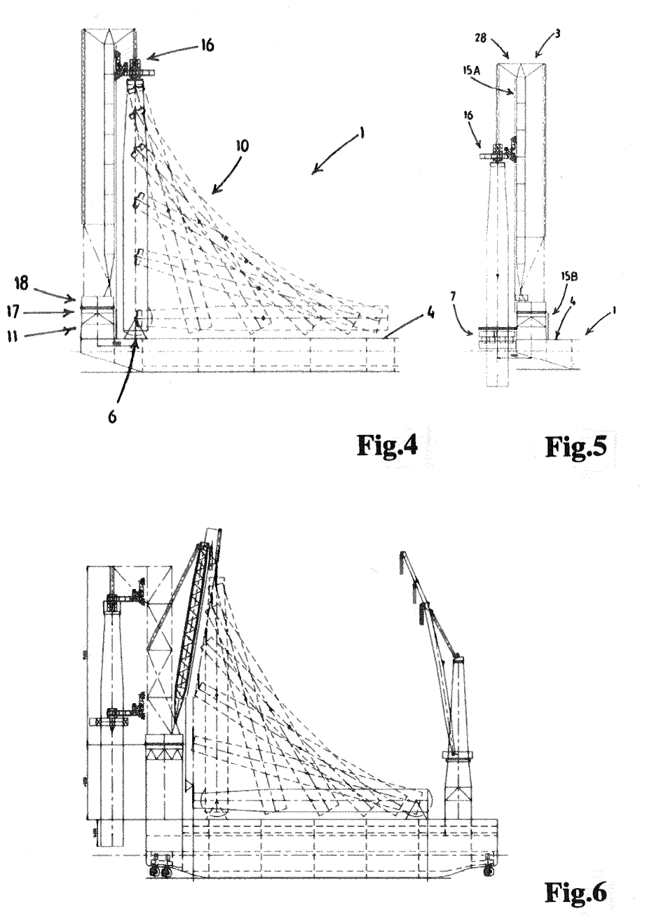

FIG. 4 shows a schematic side view of the crane of FIG. 2 with an upended monopile and with the monopile depicted in multiple upending positions;

FIG. 5 show the crane of FIG. 4 supporting a monopile in an overboard position, i.e. outside a contour of the vessel, at an installation location;

FIG. 6 shows an exemplary embodiment of a vessel provided with a upend crane according to the invention, wherein the upend crane comprises a crane tower, and a storage crane, and a monopile depicted in multiple intermediate positions of the upend process;

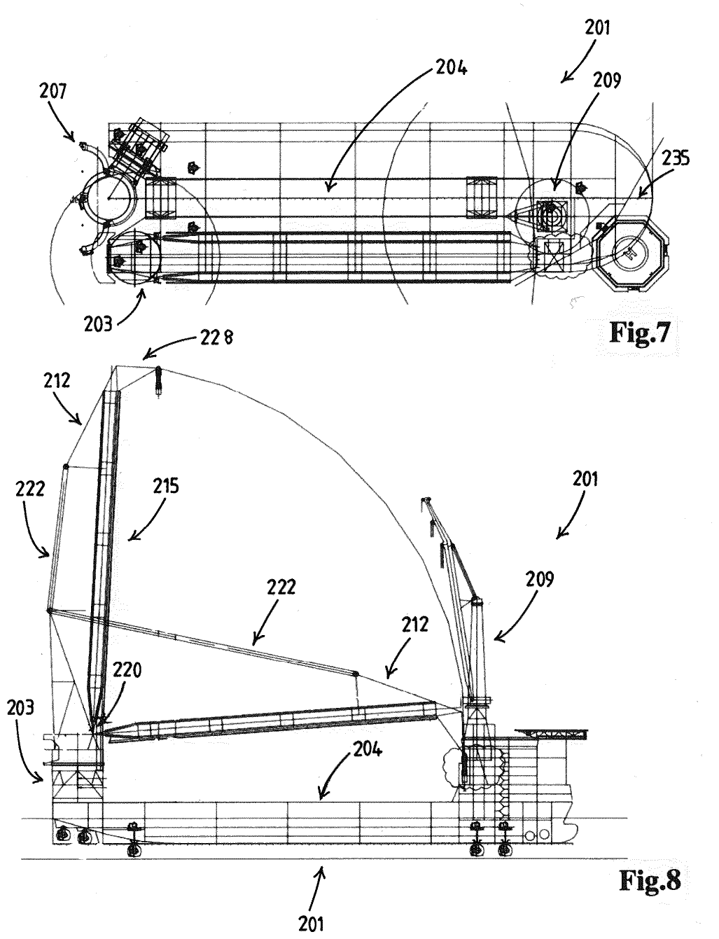

FIG. 7 shows a schematic top view of another exemplary embodiment of an installation vessel according to the invention wherein the vessel is provided with an upend crane and an upend deck that is aligned with the central axis of the vessel;

FIG. 8 shows the vessel of FIG. 7 with the boom of the upend crane depicted in both a raised upend position and a lowered position;

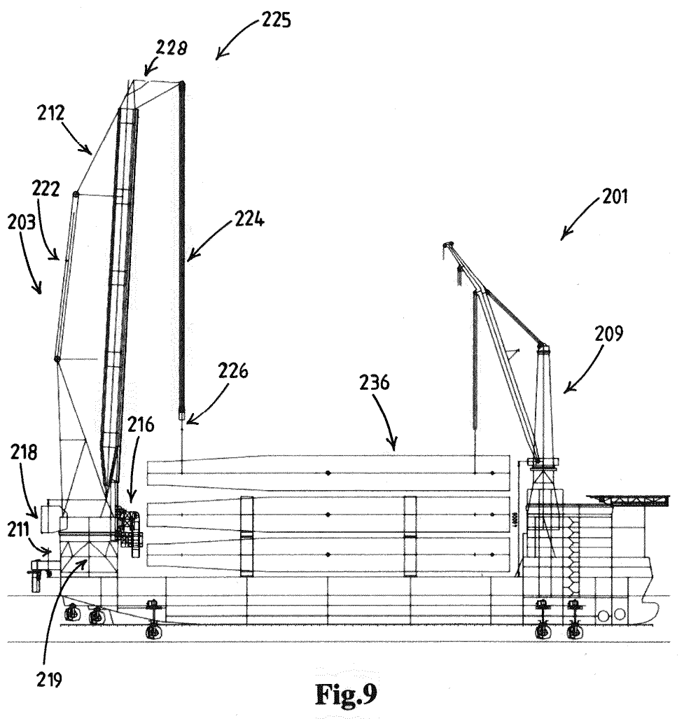

FIG. 9 shows a side view of the vessel of FIG. 7 with the upend crane and a storage crane supporting a wind turbine component;

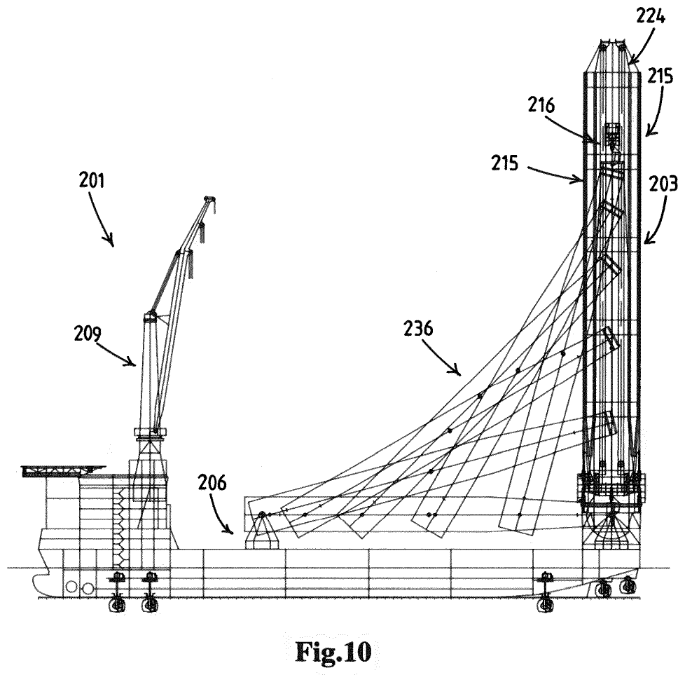

FIG. 10 shows a side view of the vessel of FIG. 7 with the boom of the upend crane in the upend position and shows a monopile depicted in multiple intermediate positions of the upend process;

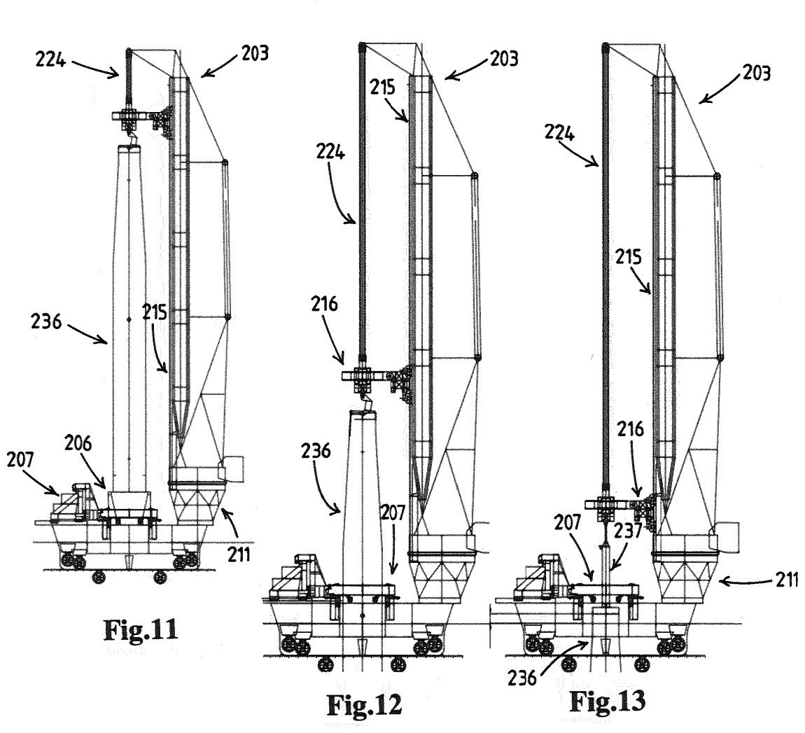

FIG. 11 show a rear view of the vessel of FIG. 10, and show the crane supporting the monopile in the gripper at the stern of the vessel;

FIG. 12 show a rear view of the vessel of FIG. 10, and show the crane lowering the monopile towards the seafloor, the monopile being guided by the gripper;

FIG. 13 show a rear view of the vessel of FIG. 10, and show the crane supporting a hammer for driving the monopile into the seafloor;

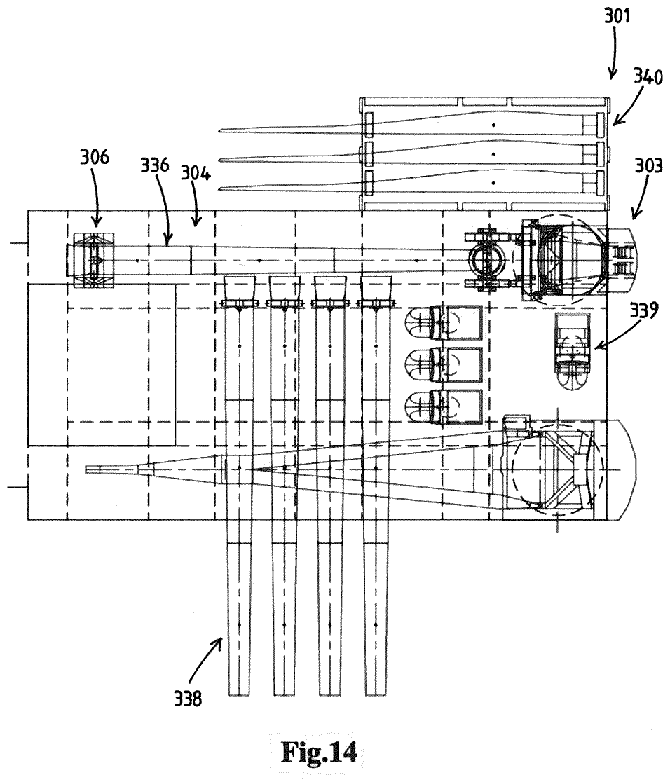

FIG. 14 shows a top view of another exemplary embodiment of a vessel according to the invention, wherein the vessel is configured for transporting wind turbine components, for assembling a wind turbine, and for mounting the assembled wind turbine on a foundation, wherein the vessel is provided with an upend crane and an upend deck that is aligned with a slew axis of the crane;

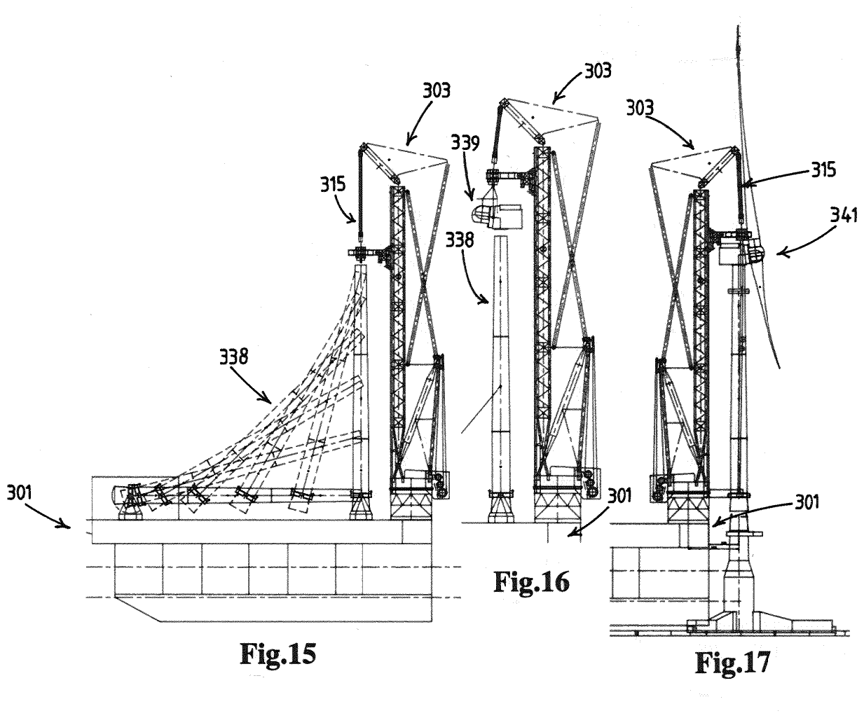

FIG. 15 shows a side view of the vessel of FIG. 14 and shows a mast depicted in multiple intermediate positions of the upend process;

FIG. 16 shows a side view of the vessel of FIG. 14 and shows the upend crane mounting a nacelle on the mast, the mast being supported in an upright position;

FIG. 17 shows a side view of the vessel of FIG. 14 and shows the upend crane supporting an assembled wind turbine in an overboard position, i.e. outside a contour of the vessel, at an installation location;

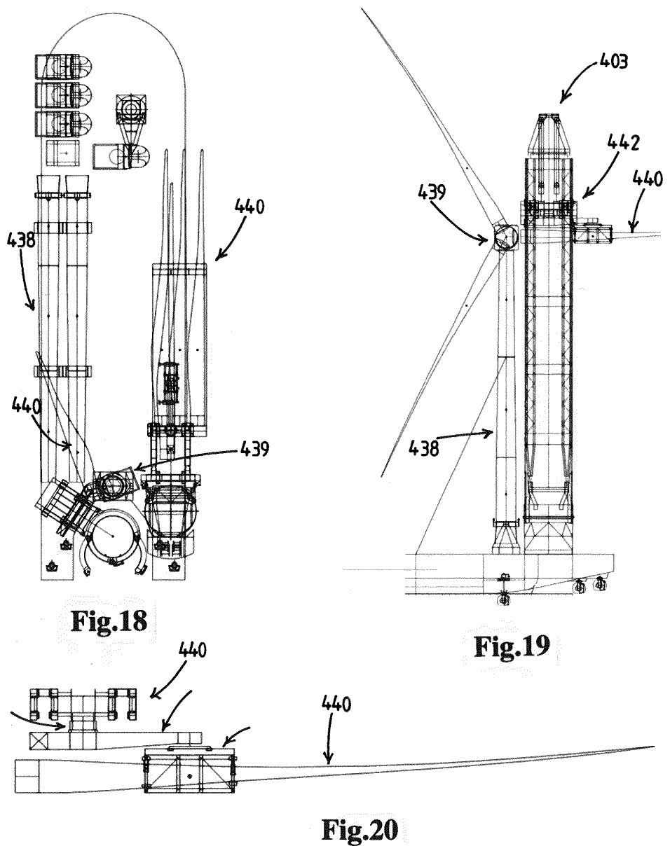

FIG. 18 shows a top view of another exemplary embodiment of a vessel according to the invention, wherein the vessel is configured for transporting wind turbine components, for assembling a wind turbine, and for mounting the assembled wind turbine on a foundation, wherein the vessel is provided with an upend crane and an upend deck that is aligned with the central axis of the vessel;

FIG. 19 shows a schematic side view of the crane of FIG. 18 with the boom of the crane in the upend position, and with a trolley supporting a blade installer device supporting a blade adjacent a nacelle of a wind turbine being assembled;

FIG. 20 shows in close up the blade installer of FIG. 19;

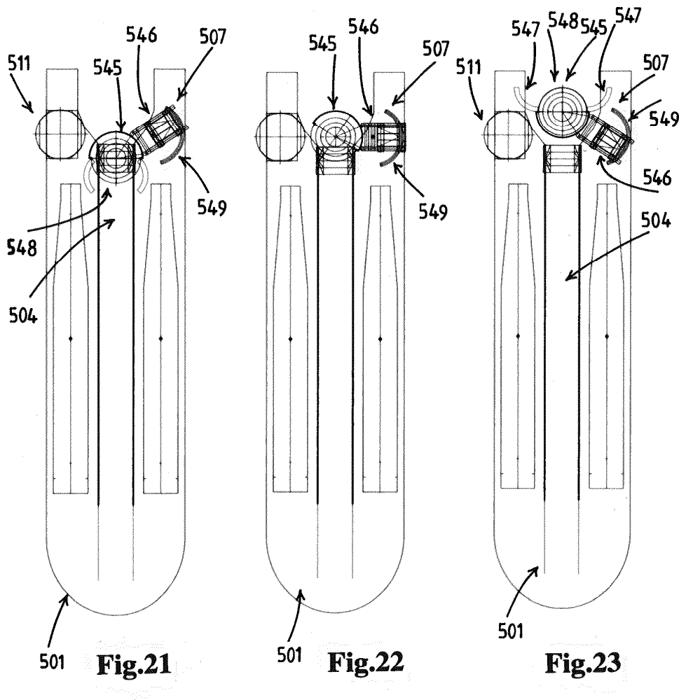

FIG. 21 shows a top view of another exemplary embodiment of a vessel according to the invention, wherein the vessel is provided with an upend crane, of which only the crane base is depicted, an upend deck that is aligned with the central axis of the vessel, and a gripper for guiding monopiles, the gripper being supported on the deck of the vessel, wherein the gripper is positioned to receive the lower end of a monopile supported by the upend crane;

FIG. 22 shows a top view of the vessel of FIG. 21, wherein the gripper moves with the crane to transfer the maniple from an onboard position to an offboard position;

FIG. 23 shows a top view of the vessel of FIG. 21, wherein the gripper is positioned to support guide the monopile at the installation location;

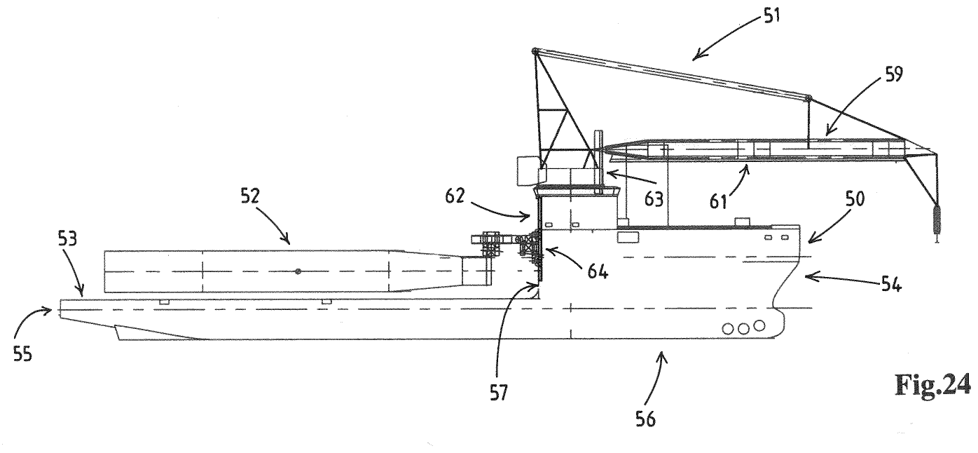

FIG. 24 shows a side view of a vessel with an upend crane according to the invention, with the upend crane in a lowered position and a foundation pile on a deck of the vessel;

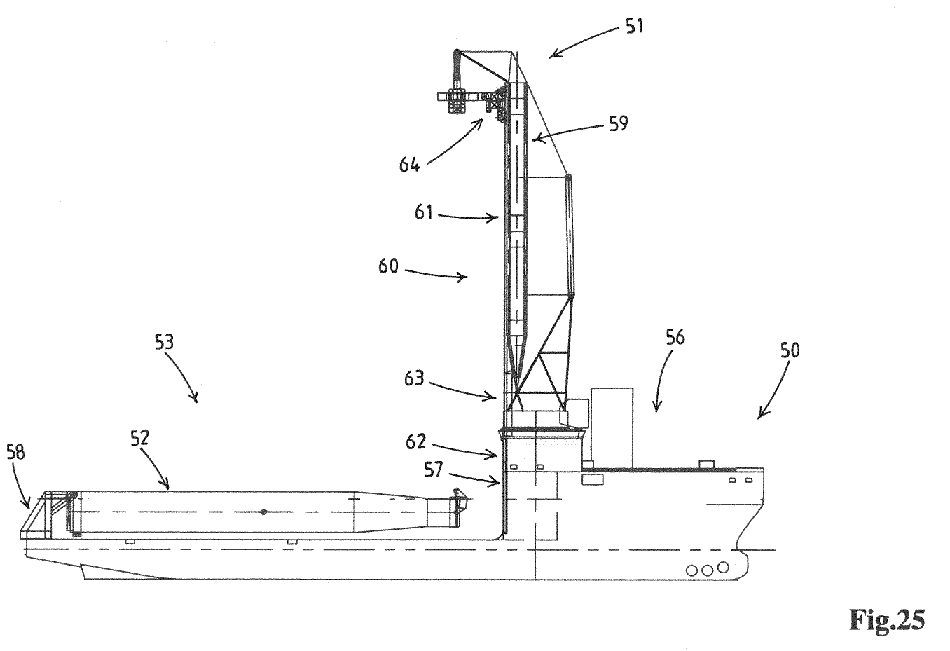

FIG. 25 shows the vessel of FIG. 24 with the upend crane in the upright position;

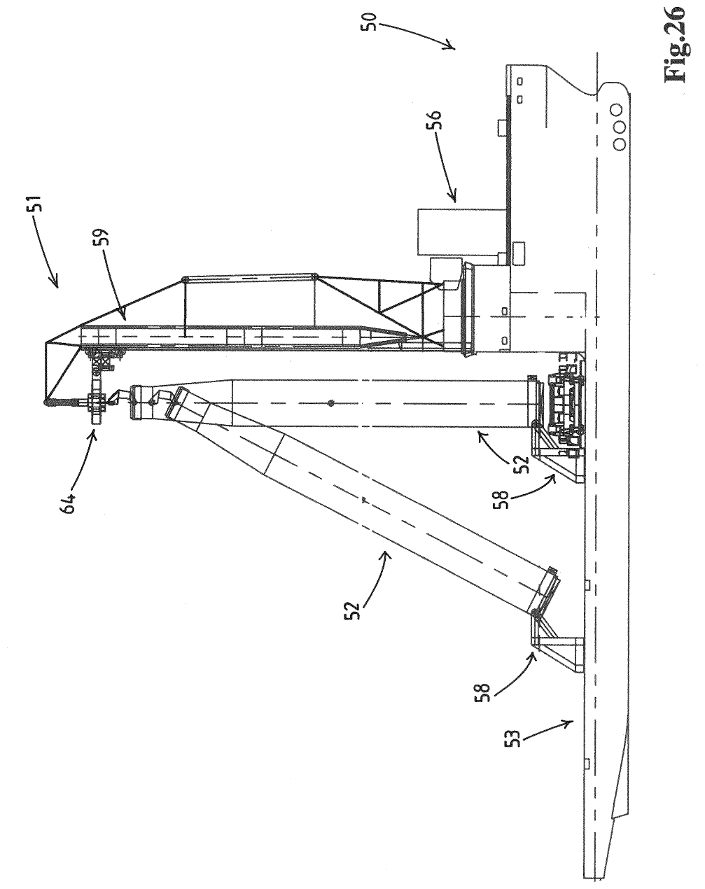

FIG. 26 shows the vessel of FIG. 25 upending the foundation pile, wherein the foundation pile is shown in an intermediate and in an upended position;

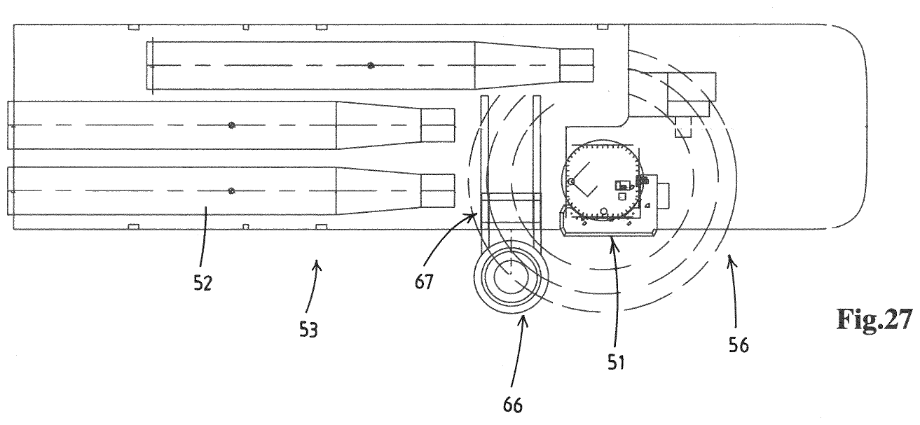

FIG. 27 shows a vessel according to the invention supporting a pile gripper next to a submersible deck;

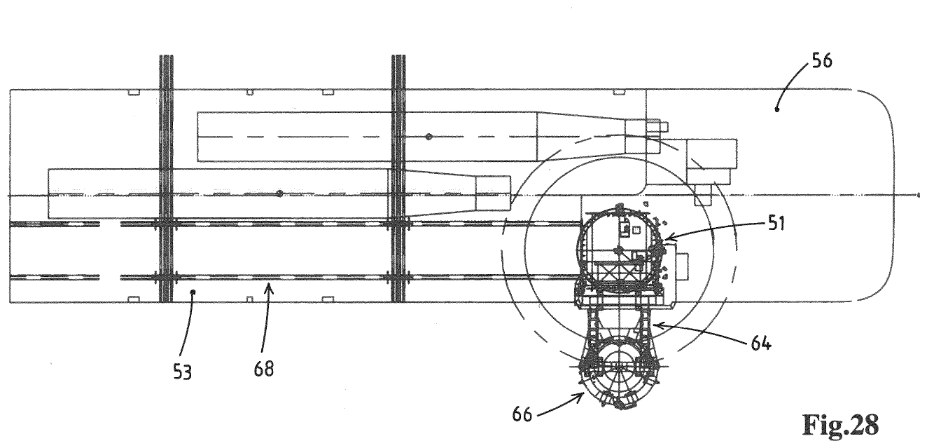

FIG. 28 shows a vessel according to the invention supporting a pile gripper next to a crane supported on a bow section of the vessel

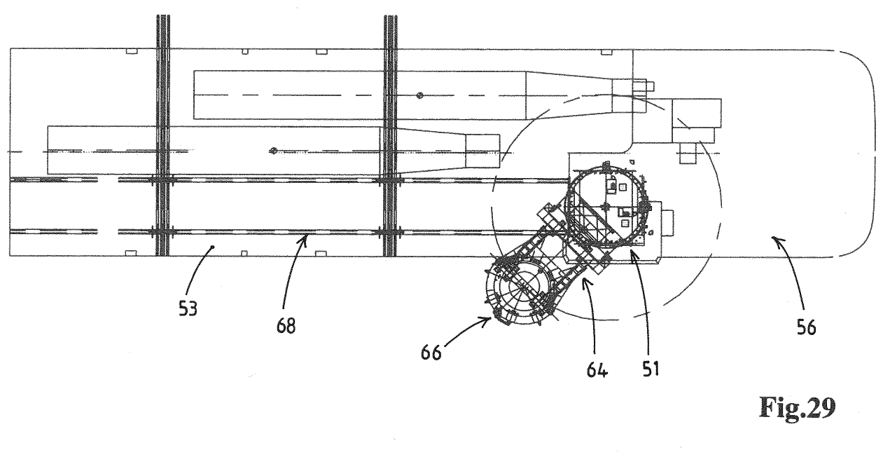

FIG. 29 shows a vessel according to the invention supporting a pile gripper in an alternative position next to a submersible deck;

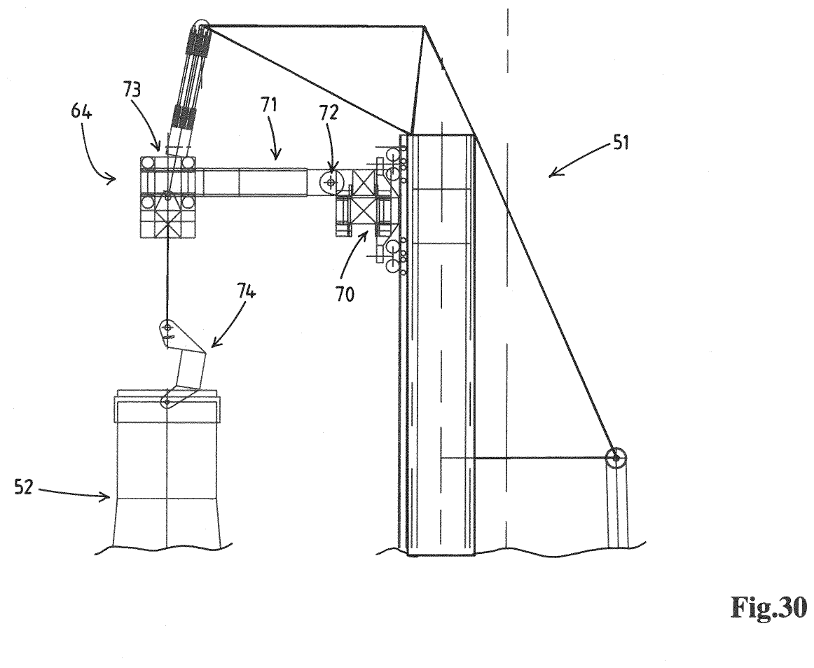

FIG. 30 shows a side view in close up of a top end of an upend crane according to the invention, wherein a pile is pushed outwards by the trolley;

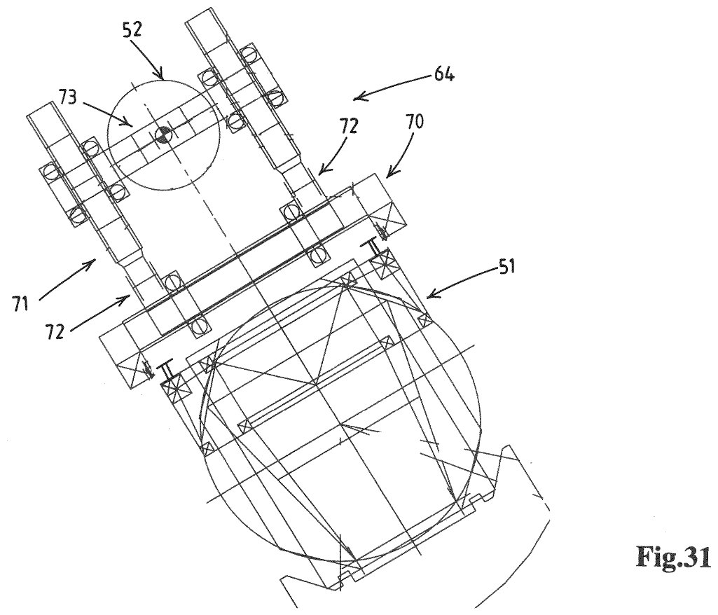

FIG. 31 shows a top view of a trolley according to the invention;

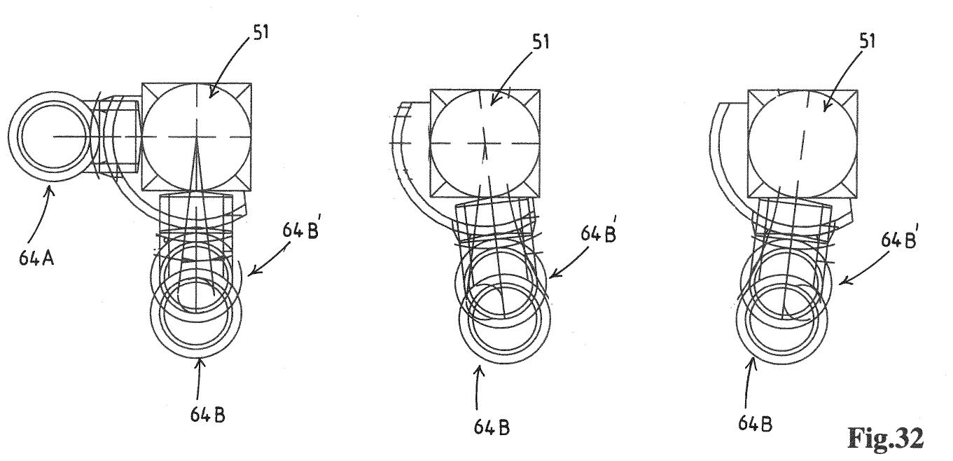

FIG. 32 shows three top views of a pile gripper that is movably mounted to a crane base;

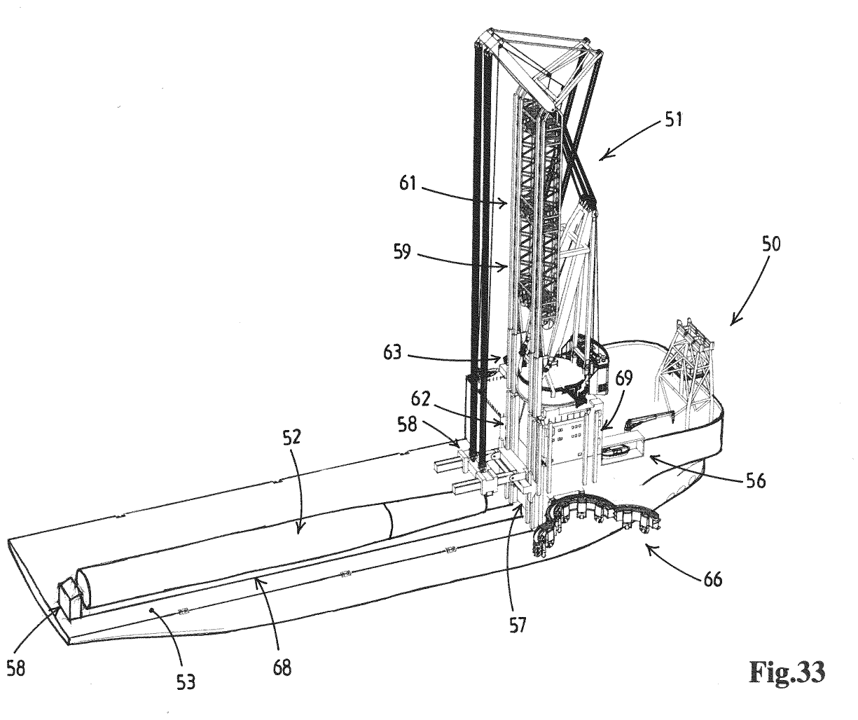

FIG. 33 shows a perspective view of a vessel with a pile gripper supported next to the bow section of the vessel;

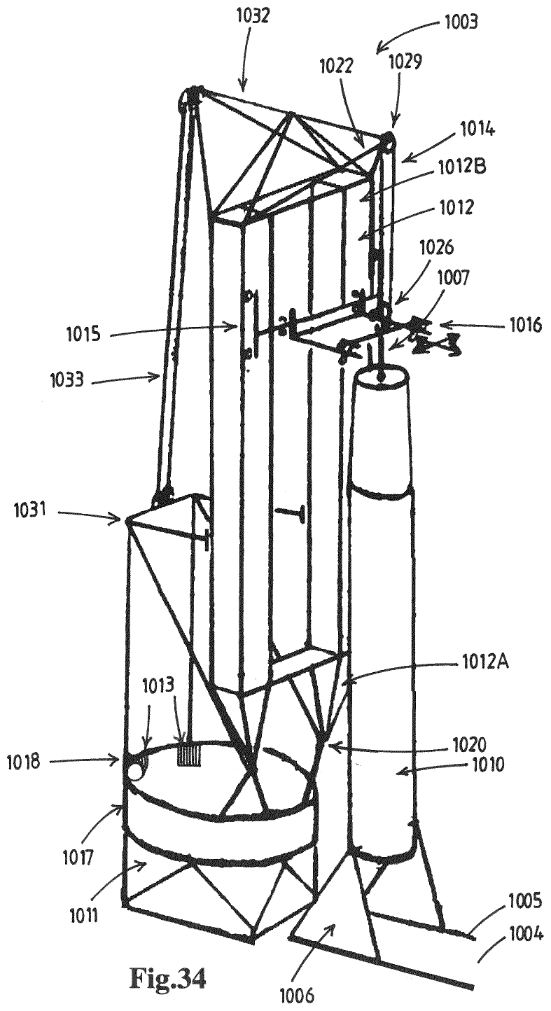

FIG. 34 shows a schematic perspective view of a crane according to the invention; and

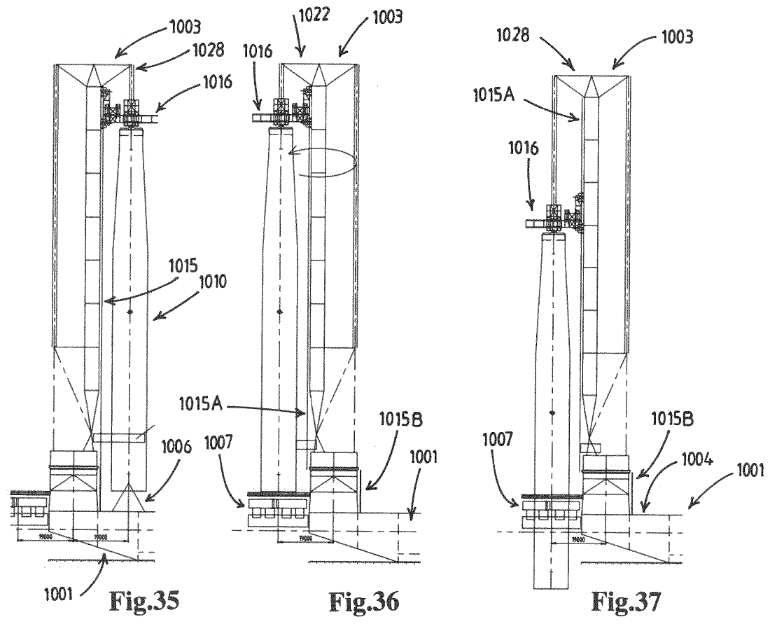

FIG. 35-FIG. 37 show subsequent steps of a monopile installation process following an upending process.

### DETAILED DESCRIPTION OF EMBODIMENTS

The installation vessel 1 comprises a hull 2, a crane 3, an upend deck 4 with a cart track 5 and a support cart 6, a monopile gripper 7 and a storage deck 8. In the embodiment shown, the vessel 1 is furthermore provided with a storage crane 9.

In the embodiment shown, the vessel 1 has a non-jack-up type floating hull 2, and is configured to maintain a position and orientation relative to an installation site. Thus, the vessel can be positioned adjacent a monopile installation site and install a monopile using the monopile gripper 7 without the vessel having to be anchored jack-up legs having to be deployed.

In the embodiment shown, the hull of the vessel forms an upend deck 4 and an storage deck 8. The upend deck and storage deck are both part of a single vessel deck. On the storage deck 8 are stored three monopiles, one next to the other. In a further embodiment according to the invention, the storage deck is provided with storage racks that allow for storage of multiple rows of monopile, one row stack upon the other.

Furthermore, a monopile 10 is depicted on the upend deck 4. The crane 1 and the storage crane 9 are configured to each engage and end of a monopile, and thus lift the monopile from the storage deck 8 onto the upend deck 4 and vice versa. In FIG. 1, the crane 3 and the storage crane 8 are depicted lifting a monopile from a position adjacent the vessel, e.g. from a supply vessel such as a barge or from a quay, prior to moving the monopile to a storage position on the storage deck 8.

FIG. 2 and FIG. 3 shows a schematic side view of the crane 3 of the vessel despite din FIG. 1.

The crane 3 is supported by the hull 2 of the vessel 1 adjacent the upend deck 4. The crane 3 comprises a crane base 11, a boom 12, a luffing winch 13, and a hoist. The crane 3 is furthermore provided with a trolley guide 15 and a trolley 16.

The crane base 11 supports a slew bearing 17 and a crane housing 18, which crane housing in turn supports the boom 12. The slew bearing 17 is provided between the crane housing 18 and the crane base 11. The slew bearing enables the crane housing 18, and thus the boom supported by the crane housing, to slew about a vertical slew axis 19.

The hoist 14 comprises a hoisting winch 23 and an associated hoisting wire 24. The hoisting wire 24 is guided via a top block 25 to a load coupling device 26 for coupling with a load, e.g. the top end of a monopile, to enable the crane to lift the load using the hoisting winch.

The boom 12 extends between a base end 12a and a top end 12b. The boom 12 is at the base end 12a pivotable supported by the crane housing 18 for pivoting about a horizontal boom pivot axis 20. Thus, the boom 12 can be pivoted between a lowered position and a raised position. In FIG. 3 the boom is depicted in both a lowered and a raised position.

The crane 3 is provided with a luffing winch 21 and an associated luffing wire 22 for pivoting and supporting the boom 12 of the crane 3 in different positions. The luffing winch 21 is mounted on the crane housing 18. The luffing wire 22 extends between the luffing winch and the boom, to enable pivoting the boom between the lowered and the raised position.

The lowered position in FIG. 3 is a storage position. This position is used during travel of the vessel between locations. By lowering the boom when not in use, the overall center of gravity of the vessel is lowered, which improves the dynamic behavior of the vessel.

The raised position depicted in FIG. 3 is an upend position. With the boom in this upright position, the crane can be used for upending monopiles, as will be explained in more detail below.

It is submitted that the boom can be pivoted, and supported, in many intermediate positions, positions raised relative to the storage position and lowered relative to the upend position, for lifting loads at a located away from the base of the crane. Furthermore, by pivoting the boom while lifting a load, that load can be moved towards or away from the crane base.

In FIG. 1, the range of the crane 3 and the storage crane 9 is depicted. It is submitted that, in the embodiment shown, the crane 3 has to lower the boom to reach a storage position on the far side of the storage deck. Furthermore, to move the monopile over the upend deck to the storage deck, one of or both the crane and the storage crane have to raise their boom, compared to the position of the boom required for lifting the monopile adjacent the vessel.

In FIG. 1 the monopile gripper is depicted in an opened and in a closed position. It is submitted that monopile grippers are generally known in the art. A monopile gripper is configured to engage a pile, and to thus position the pile, and to keep the pile in that location while the pile is lowered towards the seafloor. Typically, a monopile gripper is provided with a gripper, e.g. a circular body provided with monopile guides in the form of rollers, that can be opened to allow for the monopile to be moved into the monopile gripper, and that can be subsequently closed to position the monopile. Also, a monopile can be lowered into a closed monopile gripper. The monopile gripper has to be opened to release the monopile after the monopile is driven into the seafloor.

According to the invention, the installation vessel is configured to guide both the bottom end and the top end of a monopile during upending of that monopile. The vessel is therefore provided with the cart track 5 and the support cart 6 for guiding the bottom end of a monopile, and with the trolley guide 15 and the trolley 16 for guiding the top end of a monopile during the upending process.

The cart track 5 extends along the upend deck 4. The support cart 6 is supported by the cart track 5 to enable the cart to move along the cart track for guiding the bottom end of the monopile along the upend deck from a position distal form the crane to a position adjacent the crane. The support cart 6 is configured for supporting the bottom end of a monopile, and for allowing the bottom end of the monopile to pivot while the support cart is moved along the cart track 5.

The trolley guide 15 is mounted to the boom 12 of the crane 3 for guiding the trolley 16 along the boom 12 of the crane. Thus, when the boom 12 is raised into an upright position, the boom can be used for guiding the top end of a monopile during upending.

In the embodiment shown, the boom 12 is an A-frame, and the trolley guide comprises a track provided on both legs of the A-frame. The trolley 16 is movable mounted to each leg of the A-frame, and is thus coupled with the trolley guide for being guided along the boom of the crane.

The trolley 16 is configured to engage the load coupling device 26, supported by the hoist 14, for guiding the load coupling device, and thus for guiding the top end of the monopile supported by the load coupling device, along the trolley guide while upending the monopile using the hoist.

FIG. 4 shows a schematic side view of the crane of FIG. 2 with the boom 12 of the crane raised in the upend position. In FIG. 4, the monopile is depicted in multiple positions during upending. Thus, with a crane according to the invention, the boom of the crane can be pivoted in an upend position for upending the monopile with the bottom end of the monopile being guided by the cart and the upend track, or cart track, and with the top end of the monopile being guided by the trolley and the trolley guide.

In the exemplary embodiment shown, the load coupling device can be coupled with the top end of a monopile. The load coupling device is to be provided with a pivotable monopile top end clamp, which top end clamp has a clamp that is configured to engage and secure the top end of a monopile. The top end clamp is furthermore provided with a connector end configured to be engaged by the load coupling device. The connector end and the clamp are pivotable connected, such that the clamp can pivot relative to the connector end, and thus relative to the load coupling device, between a position for engaging a top end of a monopile in a horizontal position, corresponding to the lowered position of the trolley in FIG. 2, and a position for engaging the top end of the monopile in a vertical position, corresponding to the raised position of the trolley in FIG. 2.

It is submitted that these types of top end clamps are generally known in the prior art, and are therefore not elaborated upon.

When the load coupling device and the top end clamp are coupled, the trolley engages the load coupling device to guide the load coupling device, and thus the top end of the monopile, along the boom during upending of the monopile. In the embodiment shown, the trolley 16 and the load coupling device 26 are coupled such that the trolley moves with the load coupling device in the vertical direction. Thus, the hoist is sued to lower and raise the trolley along the boom of the crane.

FIG. 5 shows the step following the upending of the monopile. Once the monopile is upended, the crane furthermore lifts the monopile in a vertical direction from the support cart and slews about the vertical slew axis to position the monopile above the monopile gripper, see FIG. 5.

Subsequently, the crane is used to lower the monopile towards the seafloor, while the monopile is guided by the pile gripper.

In an alternative embodiment, the load coupling device supported by the hoist and the trolley are configured to be coupled, and the trolley is provided with a load coupling device configured to be coupled with the top end of the monopile, e.g. a top end clamp. in such an embodiment, the trolley is the intermediate between the load coupling device and for example a top end clamp that is mounted to the trolley.

Thus, the vessel 1 can be used for upending a monopile, the upending process comprising the steps:
lifting a monopile in a horizontal position onto the upend deck, using the crane with the boom in the lowered hoisting position for lifting one end of the monopile and a hoisting crane lifting an opposite end of the monopile, see for example FIG. 1;
moving the boom from the lowered hoisting position into the raised upending position;
engaging the monopile with the monopile engagement device, see FIG. 2;
upending the monopile using the crane with the boom in the lowered upend position for lifting one end of the monopile by moving the trolley along the boom from the lowered coupling position to the raised support position, see FIG. 4.

Furthermore, the vessel allows for, after upending, moving the pile from an upend position above the upend deck to an installation location, see FIG. 5, in which installation position the monopile is aligned with the monopile gripper, by slewing the crane about the vertical slew axis, over a slew angle of at least 180 degrees, preferably over a slew bearing angle of more than 180 degrees, e.g. over an slew angle of 190 degrees, moving the monopile from the upend deck over the side of the vessel, and subsequently towards a monopile gripper mounted to the rear end of the hull of the vessel.

In the embodiment shown, the trolley guide 15 extends below the horizontal boom pivot axis 20 when the boom is in the upend position, see for example FIG. 5. In such an embodiment, the trolley guide extends along the boom of the crane and below the boom of the crane. Thus, the trolley can not only be moved along the boom of the crane, but can be lowered below the boom of the crane, when the boom is in the upend position.

Furthermore, in the embodiment shown, the trolley guide 15 comprises a boom section 15A, which boom section is mounted to the boom 12 of the crane 1, and a base section 15B, which base section is mounted to the base 11 of the crane 1, see for example FIG. 5.

The base section 15B that is mounted to the base of the crane. Furthermore, in the exemplary embodiment shown, the base section 15B of the trolley guide is aligned with the cart track 5. Thus, the base section can be used to lower the trolley in a position close to the deck and in alignment with the cart track, see for example FIG. 2. Guiding the load coupling device close to the deck allows for engaging a monopile that is set up close to the deck.

Also, in the embodiment shown, the base section 15B of the trolley guide 15 is dimensioned to receive the trolley 16, see for Example FIG. 3. Thus, the trolley can be parked on the base section 15B of the trolley guide. When the trolley is parked on the base guide section, the boom of the crane can be operated without it supporting the trolley. This is in particular beneficial when the crane is to be used to lifting a load, and not for upending a monopile.

In the embodiment shown, the boom of the crane is provided with monopile securing arms, see FIG. 5, for engaging a lower section of a monopile supported by the crane in a vertical position. Thus securing the position of the monopile relative to the boom prevents sway of the monopile during slewing of the crane while supporting the monopile in the vertical position.

In the embodiment shown, the boom 12 comprises a jib 28. Furthermore, the upper sheave assembly 29 is provided in the jib 28 such that the hoisting wire 24, when the load coupling device 26 is received in the trolley 16, is positioned away from the boom 12. Thus, the hoisting wire 24, or more in particular the section of the hoisting wire that is luffed between the upper sheave assembly 29 and the lower sheave assembly 30, is aligned with the monopile supported by the crane in the vertical position.

Furthermore, the part of the hoisting wire 24 that extends between the trolley 16 and the upper sheave assembly 29 runs parallel to the trolley guide 15.

In the exemplary embodiment shown, the boom 12 at the base end 12A comprises a gantry 31, and at the top end 12B comprises with a gantry jib 32, and is provided with gantry wires 33 extending between the gantry 31 and the gantry jib 32. Furthermore he luffing wire extending between the luffing winch and the boom, more in particular extending between the luffing winch and the gantry of the boom.

FIG. 6 shows an embodiment of a crane 103 according to the invention, wherein the crane 103 in addition to a boom 112 that can be raised in an upend position, comprises a crane tower 134 for supporting a monopile on a side of the crane opposite the boom. The crane tower 34 is configured for supporting a monopile in the monopile gripper 107 and for lowering the monopile in a vertical position into the water adjacent the vessel 101. The crane tower 134 extends between a base end 134A and a top end 134B, and is mounted in a fixed and upright position on the crane housing 118 for rotation with the boom 112 of the crane 101 about the vertical slew axis. The crane tower 134 is provided with a
a trolley 116, configured to support a monopile at the top end thereof;
a trolley guide 115, e.g. a track comprising one or more guide rails, for guiding the trolley along the crane tower 134;
a hoisting winch 123 and an associated hoisting wire, wherein the hoisting wire is guided via the top of the crane tower for hoisting the trolley along the trolley guide for lowering the monopile towards the seafloor.

FIG. 7 shows a schematic top view of another exemplary embodiment of an installation vessel 201 according to the invention wherein the vessel is provided with an upend crane 203 and an upend deck 204 that is aligned with the central axis 235 of the vessel.

FIG. 8 shows the vessel 201 of FIG. 7 with the boom 212 of the upend crane 203 depicted in both a raised upend position and a lowered position.

FIG. 9 shows a side view of the vessel 201 of FIG. 7 with the upend crane 203 and a storage crane 209 supporting a wind turbine component 236.

FIG. 10 shows a side view of the vessel of FIG. 7 with the boom 212 of the upend crane 203 in the upend position and shows a monopile 236 depicted in multiple intermediate positions of the upend process.

FIG. 11-13 show how the process following the upending of the monopile 236. Once the monopile 236 is upended, the crane 203 furthermore lifts the monopile in a vertical direction from the support cart 206 and slews about the vertical slew axis 219 to position the monopile above the monopile gripper 207, see FIG. 11. Subsequently, the crane 203 is used to lower the monopile 236 towards the seafloor, while the monopile is guided by the pile gripper 207, see FIG. 12. Once the monopile 236 is landed on the seafloor, the crane 203 is used to mount a hammer 237 on top of the monopile 236, and the monopile is driven into the seafloor, see FIG. 13.

FIG. 14 shows a top view of another exemplary embodiment of a vessel 301 according to the invention, wherein the vessel is configured for transporting wind turbine components, for assembling a wind turbine, and for mounting the assembled wind turbine on a foundation. The vessel 301 is provided with an upend crane 303 and an upend deck 304 that is aligned with a slew axis 319 of the crane 303.

FIG. 15 shows a side view of the vessel 301 and shows a mast 338 depicted in multiple intermediate positions of the upend process.

FIG. 16 shows a side view of the vessel 301 and shows the upend crane 303 mounting a nacelle 339 on the mast 338, the mast being supported in an upright position.

FIG. 17 shows a side view of the vessel 301 and shows the upend crane 303 supporting an assembled wind turbine 341 in an overboard position, i.e. outside a contour of the vessel 301, at an installation location.

FIG. 18 shows a top view of another exemplary embodiment of a vessel 401 according to the invention, wherein the vessel 401 is configured for transporting wind turbine components, for assembling a wind turbine, and for mounting the assembled wind turbine on a foundation. The vessel 401 is provided with an upend crane 403 and an upend deck 404 that is aligned with the central axis 435 of the vessel 401.

In the embodiment shown, the vessel is provided with a wind turbine assembly station at one end of the upend deck. On the crane side of the upend deck are stored multiple wind turbine blades and on the pile gripper side are stored multiple wind turbine masts.

In this embodiment, a mast is moved to the upend deck, and is upended using the upend crane. Once the mast is in the upright position, the lower end of the mast is secured in a mount. Thus the crane can release the mast, and be used for lifting wind turbine components.

FIG. 19 shows a schematic side view of the crane 403 with the boom 412 of the crane in the upend position, and with a trolley 416 supporting a blade installer device 442 supporting a blade 440 adjacent a nacelle 439 of a wind turbine being assembled.

FIG. 20 shows in close up the blade installer device 442. The blade installer device comprises an arm that can reach out from the trolley, for engaging a cradle holding a wind turbine, see FIG. 18, and for positioning the blade adjacent the hub of a nacelle mounted on the upright wind turbine mast, see FIG. 19.

It is submitted that when the vessel is used for assembling, the monopile gripper may be removed from the vessel. In an embodiment replaced with a foundation gripper, i.e. a gripper for securing the vessel relative to a foundation. In yet another embodiment, a pile gripper is provided that is configured to also engage a wind turbine foundation.

FIG. 21 shows a top view of another exemplary embodiment of a vessel 501 according to the invention. The vessel 501 is provided with an upend crane 503, of which only the crane base 511 is depicted, an upend deck 504 that is aligned with the central axis 535 of the vessel, and a gripper 507 for guiding monopiles 536.

In the embodiment shown, the vessel 501 comprises a recess 543, i.e. a setback in the contour of the vessel, at the aft of the vessel. The recess 543 is flanked by two deck portions 544. The gripper is a mono pile gripper 507 configured to guide a monopile 535, which is supported by the upend crane 503 in the recess 543.

In the particular embodiment shown, the monopile gripper is comprises a gripper ring 545 for guiding the monopile, and a frame 546 for supporting the gripper ring outside the contour of the vessel and for moving the gripper ring in the horizontal plane to compensate for movements of the vessel relative to the installation site, and thus relative to the pile supported at the installation site.

The gripper ring 545 is provided with two door sections 547, which in a closed position form part of the gripper ring, and which can be opened to provide an entry opening that allows for the monopile to be moved into or out of the gripper ring in a lateral direction relative to the gripper ring. FIG. 21 depicts the ring with the door sections closed, FIG. 21 and FIG. 23 shows the ring with the door sections opened.

In the particular embodiment shown, the gripper ring 545 is movable supported by the support frame 546, such that the gripper ring can be rotated about a vertical axis, and thus the entry opening 548 of the gripper ring can be moved. Thus, the gripper ring 456 can be positioned with the entry opening 548 facing the bow of the vessel for receiving a monopile supported by the upend crane 503 at the upend position, as shown in FIG. 21, and can be positioned with the entry opening facing the aft of the vessel for allowing a monopile that is driven into the sea floor to be move out of the gripper ring by the vessel moving away from the installation location. The latter position of the gripper ring is shown in FIG. 23.

Furthermore, in the exemplary embodiment shown. the support frame 546 is pivotable supported with one end mounted on a semi-circular support track 549, such that the frame can be pivoted about a vertical pivot axis, see FIGS. 21-23. The frame is configured to telescopically support the gripper ring, such that it can move the gripper ring towards and away from the semi-circular track. Thus, the gripper ring can be moved in the horizontal plane relative to the vessel, and the gripper ring can move with the lower end of a monopile being moved along the central axis of the vessel from an onboard position into an overboard position. Thus, the monopile is fully supported, at its top end by the trolley and at its lower end by the gripper ring, while the monopile is moved.

The gripper 507 is supported on the deck of the vessel 501. The gripper 507 is positioned to receive the lower end of a monopile 535 supported by the upend crane 503.

FIG. 22 shows a top view of the vessel 501. The gripper 507 moves with the crane to transfer the monopile 535 from an onboard position, depicted in FIG. 21, to an offboard position, depicted in FIG. 23.

FIG. 23 shows a top view of the vessel 501, wherein the gripper 507 is positioned to guide the monopile 535 at the installation location.

FIG. 24 shows a side view of a vessel 50 with an upend crane 51 according to the invention. The upend crane 51 is shown in a lowered position. A foundation pile 52 is in a horizontal position on a submersible deck 53 of the vessel.

The vessel 50 shown in FIG. 24 is a monohull vessel provided. The vessel comprises an elongated hull extending between a bow 54 and an aft 55 of the vessel.

The elongated hull has a bow section 56 that supports the crane 51, and the elongated hull supports the submersible deck 53. The submersible deck 53 extends from the bow section 56 towards the aft of the vessel. The submersible deck 53 is recessed in the hull structure relative to the bow section 56, such that the bow section has a vertical hull surface 57 facing towards the submersible deck 53 and the aft of the vessel 50.

The upend crane 51 is supported by the bow section 56 of the hull, adjacent the submersible deck 53 and adjacent a side of the vessel.

The submersible deck comprises an upend deck that is provided with a cart track and a support cart 58 for guiding a bottom end of a pile. The cart track extends parallel to a longitudinal axis of the vessel 50 between a track end distal from the bow section and a track end adjacent the bow section.

The submersible deck 53 of the vessel 50 comprises a storage deck adjacent the upend deck. The storage deck is provided with storage racks, not shown, for supporting multiple piles in a horizontal position parallel to the cart trac, and thus parallel to the longitudinal axis of the vessel.

FIG. 24 shows a single pile 52 in a position on the storage deck. The upend crane 51 is shown with the boom 59 in a lowered position, which is used when the vessel travels between locations.

According to the invention, the upend crane 51 comprises a boom 59 with a trolley guide 60. In the embodiment shown, the trolley guide 60 comprises a boom section 61, that is mounted to the boom of the crane, and a base section 62 that is mounted to the base of the crane. In the particular embodiment shown, the trolley guide also comprise an intermediate section 63 that, when the boom of the crane is in the upend position, forms an intermediate between the boom section 61 and the base section 63 of the trolley guide 60.

Furthermore, in the embodiment shown, the base section 62 of the trolley guide is provided on the side of the crane base that faces the submersible deck 53 of the vessel, and extends from the crane base downward along the vertical hull surface 57 of the bow section that faces the submersible deck. Therefore, a trolley 64 can be lowered along that vertical hull surface towards the submersible deck 53.

FIG. 25 shows the upend crane 51 with the boom in the upright position, for upending for example foundation piles. The boom section, intermediate section and base section of the trolley guide are aligned, and thus from a trolley guide for moving the trolley 64 between a lowered position near the deck of the vessel and a raised position at the top of the boom of the upend crane. Thus, with the upend crane in this position, the trolley can be used for upending the monopile positioned on the upend deck.

FIG. 26 shows the vessel 50 upending the foundation pile 52. The foundation pile 52 is shown in an intermediate position and in an upended, upright, position.

The bottom end of the foundation pile is guided by a support cart, that moves along the cart track on the upend deck during the upending of the foundation pile.

In the embodiment shown, the support cart 58 is configured to pivotably engage the bottom end of the pile, such that the support cart can hold the bottom end of the foundation pile when it is supported by the upend crane above a pile gripper 66, or at least above a pile gripper support construction that supports the pile gripper in a position next to the vessel for guiding the foundation pile when it is lowered by the upend crane into the sea.

In the embodiment shown, the pile holder 66 is supported by a pile holder support configuration that is mounted on the deck 53 of the vessel between an end of the cart track 68 and the bow section. FIG. 27 shows a top view of the vessel 50 with the pile gripper 66 and the pile gripper support construction 67 mounted to the deck 53 of the vessel.

FIGS. 28 and 29 show alternative positions of the pile gripper. It is submitted that the pile gripper is preferably positioned with its center on the turn radius of the crane, such that an upended crane can be moved into a position aligned with the pile gripper by simply slewing the crane.

FIG. 28 shows a vessel according to the invention supporting a pile gripper next to a crane supported on a bow section of the vessel

FIG. 29 shows a vessel according to the invention supporting a pile gripper in an alternative position next to a submersible deck.

FIG. 33 shows a perspective view of the vessel 50, wherein the pile gripper is supported next to the bow section of the vessel. In this embodiment, the trolley guide comprises a secondary base section 69, extending along the base of the crane at the side that faces the side of the vessel, and along the hull of the bow, to enable the trolley to be lowered towards the sea surface, and towards the pile gripper supported at the side of the vessel.

FIG. 30 shows a side view in close up of a top end of an upend crane according to the invention, wherein a pile is pushed outwards by the trolley. Thus, the pile can be positioned above a pile gripper without the boom of the upend crane having to be moved out of the FIG. 31 shows a top view of a trolley according to the invention. In the embodiment shown, the trolley 64 comprises a trolley frame that is movable supported by the trolley guide, part of which is mounted to the boom 59 of the upend crane 51. The trolley frame movable supports two support arms 71, such that the support arms can be moved in a horizontal direction along the trolley frame.

In the embodiment shown, the support arms are pivotable. The support arms are shown in an active position, and can be pivoted in an inactive upright position about a pivot axis 72.

The support arms movable support a cross beam 73, such that it can move along the support arms. In the embodiment shown, the cross beam is coupled with the hoisting device, such that the crane can lift and lower the trolley along the trolley guide.

By moving the support arms relative to the trolley frame, and by moving the cross beam along the support arms, a wind turbine engagement element 74 supported by the trolley can be moved in a horizontal plane, relative the boom of the upend crane.

When the trolley is disconnected from the hoisting assembly of the crane, and for example is parked on a base section of the trolley guide, the hoisting assembly can be used for free lifting objects, i.e. without being guided by the trolley and with the boom in a pivoted position, i.e. not in the upright upend position.

FIG. 34 shows a schematic perspective view of a crane 1003 according to the invention.

The crane 1003 is supported by a hull 1002 of a vessel 1001 adjacent an upend deck 1004. The crane 1003 comprises a crane base 1011, a boom 1012, a luffing winch 1013, and a hoist. The crane 1003 is furthermore provided with a trolley guide 1015 and a trolley 1016.

The crane base 1011 supports a slew bearing 1017 and a crane housing 1018, which crane housing in turn supports the boom 1012. The slew bearing 1017 is provided between the crane housing 18 and the crane base 1011. The slew bearing enables the crane housing 1018, and thus the boom supported by the crane housing, to slew about a vertical slew axis 1019.

The hoist 1014 comprises a hoisting winch 1023 and an associated hoisting wire 1024. The hoisting wire 1024 is guided via a top block 1025 to a load coupling device 1026 for coupling with a load, e.g. the top end of a monopile, to enable the crane to lift the load using the hoisting winch.

The boom 1012 extends between a base end 1012a and a top end 1012b. The boom 1012 is at the base end 1012a pivotable supported by the crane housing 1018 for pivoting about a horizontal boom pivot axis 1020. Thus, the boom 1012 can be pivoted between a lowered position and a raised position.

The crane 1003 is provided with a luffing winch 1021 and an associated luffing wire 1022 for pivoting and supporting the boom 1012 of the crane 1003 in different positions. The luffing winch 1021 is mounted on the crane housing 1018. The luffing wire 1022 extends between the luffing winch and the boom, to enable pivoting the boom between the lowered and the raised position.

FIG. 35-FIG. 37 show subsequent steps of a monopile installation process following an upending process, this process following the upending of the monopile. Once the monopile is upended, the crane furthermore lifts the monopile in a vertical direction from the support cart, see FIG. 35, and slews about the vertical slew axis to position the monopile above the monopile gripper, see FIG. 36. Subsequently, the crane is used to lower the monopile towards the seafloor, while the monopile is guided by the pile gripper, see FIG. 37.

In an alternative embodiment, the load coupling device supported by the hoist and the trolley are configured to be coupled, and the trolley is provided with a load coupling device configured to be coupled with the top end of the monopile, e.g. a top end clamp. in such an embodiment, the trolley is the intermediate between the load coupling device and for example a top end clamp that is mounted to the trolley.

1.-40. (canceled)

41. An upend crane configured to be supported by a hull of a vessel adjacent an upend deck of the vessel for upending of wind turbine components, wherein the upend crane comprises:
a crane base;
a crane housing and a slew bearing provided between the crane base and the crane housing, wherein the slew bearing enables the crane housing to slew about a vertical slew axis;
a boom, wherein the boom extends between a base end and a top end, wherein the boom is, at the base end, pivotable supported by the crane housing about a horizontal boom pivot axis for pivoting between a lowered position for lifting a load at a distance from the crane base and a raised upend position for upending wind turbine components adjacent the crane base;
a luffing winch and an associated luffing wire, wherein the luffing winch is mounted on the crane housing and the luffing wire extends between the luffing winch and the boom to enable pivoting of the boom between the lowered position and the raised upend position;
a hoist, wherein the hoist comprises a hoisting winch and an associated hoisting wire, wherein the hoisting wire is guided via an upper sheave assembly in the boom to a lower sheave assembly of a load coupling device for coupling with a load to enable the crane to lift the load using the hoisting winch;
a trolley guide comprising one or more guide rails mounted to the boom of the crane; and
a trolley, coupled with the trolley guide for being guided along the boom of the crane, wherein the trolley is provided with a wind turbine component engagement device configured to pivotably support a wind turbine component at a top end thereof, or wherein the trolley is configured to receive a wind turbine component engagement device and/or a load coupling device supporting a wind turbine component engagement device.

42. The upend crane according to claim 41, wherein the crane further comprises a boom securing device, the boom securing device comprising a stop for positioning the boom in the upend position, and a boom locking device for securing the boom in the upend position.

43. The upend crane according to claim 41, wherein the crane further comprises a boom mobiliser for moving the boom out of the upend position.

44. The upend crane according to claim 41, wherein the trolley guide extends from above to below the horizontal boom pivot axis when the boom is in the upend position.

45. The upend crane according to claim 41, wherein the trolley guide comprises a boom section mounted to the boom of the crane, and a base section mounted to the base of the crane, and the trolley is configured to be lowered from the boom section onto the base section for coupling the trolley with a top end of a wind turbine component using the wind turbine component engagement device, and wherein the trolley is configured to be moved from the base section onto the boom section to upend the wind turbine component coupled to the trolley.

46. The upend crane according to claim 41, wherein an active horizontal motion device is mounted between the trolley and the load coupling device, when received in the trolley, and/or a wind turbine component engagement device supported by the load coupling device, the active horizontal motion device being adapted to actively compensate for sea-state induced horizontal displacement of the wind turbine component engagement device in two non-parallel horizontal directions, while the wind turbine component is supported in an upright position by the wind turbine component engagement device.

47. The upend crane according to claim 41, wherein the crane further comprises a crane tower for supporting a wind turbine component on a side of the crane opposite the boom, wherein the crane tower extends between a base end and a top end thereof, and wherein the crane tower is mounted in a fixed and upright position on the crane housing for rotation with the boom of the crane about the vertical slew axis,
wherein the crane tower is provided with:
a support trolley, configured to support a wind turbine component at the top end thereof;
a trolley guide comprising one or more guide rails, for guiding the trolley along the crane tower; and
a hoisting winch and an associated hoisting wire, wherein the hoisting wire is guided via the top of the crane tower for hoisting the trolley along the trolley guide for lifting and lowering the wind turbine component.

48. The upend crane according to claim 41, wherein the boom comprises a jib, and wherein the upper sheave assembly is provided in the jib such that the hoisting wire, when the load coupling device is received in the trolley, is positioned away from the boom, and is positioned at the position of a central axis of a wind turbine component supported in a vertical position by the trolley.

49. The upend crane according to claim 48, wherein the part of the hoisting wire that extends between the trolley and the upper sheave assembly runs parallel to the trolley guide.

50. The upend crane according to claim 41, wherein the boom at the base end thereof comprises a gantry, and at the top end thereof comprises a gantry jib, and is provided with one or more gantry wires extending between the gantry and the gantry jib, and wherein the luffing wire extends between the luffing winch and the gantry of the boom.

51. The upend crane according to claim 41, wherein the gripper is x-y compensated and configured to position a monopile, supported in an upright position, in the X-Y plane, and thus compensate for movement of the vessel relative to a monopile installation location.

52. The upend crane according to claim 41, wherein the trolley is provided with a wind turbine component engagement device configured to pivotably support a wind turbine component at the top end thereof, and wherein the trolley is configured to be coupled with the load coupling device of the hoist.

53. The upend crane according to claim 41, wherein the trolley is configured to receive a wind turbine component engagement device supported by the load coupling device of the hoist.

54. The upend crane according to claim 41, wherein the trolley is configured to receive the load coupling device of the hoist, the load coupling device supporting a wind turbine component engagement device configured to pivotably support a wind turbine component at the top end thereof.

55. The upend crane according to claim 41, wherein the crane further comprises a trolley hoist comprising a trolley hoisting winch with an associated trolley hoisting wire, and wherein the trolley hoisting wire is guided via a crown block to the trolley for moving the trolley along the trolley guide.

56. The upend crane according to claim 41, wherein the crane further comprises a secondary hoist comprising a secondary hoisting winch with an associated secondary hoisting wire supporting a secondary load coupling device configured to be connected to a load, and wherein the hoisting wire is guided via a crown block to the load coupling device for lifting a load at a distance from the crane base using the secondary hoisting winch.

57. An installation vessel for installation of wind turbine components, the installation vessel comprising:
a hull, the hull forming an upend deck;
the upend crane according to claim 41, wherein the upend crane is supported by the hull of the vessel adjacent the upend deck;
a cart track, extending along the upend deck;
a support cart for supporting a bottom end of the wind turbine component, wherein the support cart is supported by the cart track to enable the cart to move along the cart track for guiding the bottom end of the wind turbine component along the upend deck from a position distal from the crane to a position adjacent the crane; and
a gripper, the gripper extending outside a contour of the vessel.

58. The vessel according to claim 57, wherein the vessel further comprises a storage deck supported by the hull of the vessel, wherein the storage deck is provided with storage racks for supporting multiple wind turbine components in a horizontal position, wherein the storage deck and the storage racks are configured to support multiple wind turbine components parallel to each other.

59. The vessel according to claim 58, wherein the crane is located at one end of the storage deck, and wherein the vessel is provided with a storage crane at an opposite end of the storage deck, and wherein the crane and the storage crane are configured to together lift wind turbine components from the storage deck to the upend deck, the crane and the storage crane each lifting an end of the wind turbine component.

60. The vessel according to claim 58, wherein the upend deck and storage deck are both part of a single vessel deck.

61. The vessel according to claim 58, wherein the upend deck and the crane are configured such that the wind turbine component, when supported in a horizontal position on the upend deck and with the top end of the wind turbine components coupled to the load coupling device, is parallel to a longitudinal axis of the vessel.

62. The vessel according to claim 58, wherein the cart track is aligned with the slew axis of the crane, such that a central axis of the wind turbine component supported at one end by the cart and at an opposite end coupled with the trolley is aligned with the slew axis of the upending crane.

63. The vessel according to claim 58, wherein the upend deck with the cart track is located on the central axis of the vessel, and the crane is mounted away from the central axis of the vessel, along the side of the vessel, and wherein the cart track is thus not aligned with the slew axis of the upending crane.

64. The vessel according to claim 58, wherein the gripper is a monopile gripper and is located at a stern of the vessel and on a central longitudinal axis of the vessel.

65. The vessel according to claim 64, wherein the vessel comprises a recess at an aft of the vessel, the recess being flanked by two deck portions, and wherein the gripper is a monopile gripper configured to guide a monopile in the recess, and wherein the monopile gripper is mounted on one of the deck portions and the upend crane is mounted on the opposite deck portion.

66. The vessel according to claim 65, wherein the upend deck is provided on a central axis of the vessel, and is aligned with the recess, and wherein on opposite sides of the upend deck, storage decks are provided, the storage decks being aligned with the deck portions, and wherein the storage deck aligned with the deck portion on which the crane is mounted, is provided with storage for wind turbine blades.

67. The vessel according to claim 58, wherein the vessel is provided with a wind turbine assembly station at an end of the upend deck and adjacent the upend crane for assembling a wind turbine including mounting a nacelle on a mast and providing the nacelle with blades.

68. The vessel according to claim 58, wherein the crane comprises a blade installer device, the blade installer device being mountable to the trolley for supporting wind turbine blades and for positioning the blade relative to a nacelle mounted on a mast supported in a wind turbine assembly station adjacent the upend crane,
wherein the blade installer device comprises:
a base configured to be mounted to the trolley, or to be integrated with a dedicated trolley;
a connector, wherein the connector is configured for engaging a wind turbine blade, or for engaging a blade support removably mounted on the blade; and
a pivot arm, which at a base end is connected to the base for, in use, pivoting about a vertical axis, and is at an opposite end connected to the connector for, in use, pivoting about a vertical axis.

69. The vessel according to claim 58, wherein the trolley is configured for supporting an assembled wind turbine, and wherein the upend crane is provided with a second trolley for engaging the mast of the assembled wind turbine at a lower end thereof to stabilise the wind turbine when supported by the upend crane.
